(19) United States
(12) Patent Application Publication
(10) Pub. No.: US 2013/0018711 A1
(43) Pub. Date: Jan. 17, 2013

(54) BUYER GROUP DEFINITION AND ASSOCIATION IN A DEMAND DRIVEN PROMOTION SYSTEM

(71) Applicants: Christopher C. Winslade, Chicago, IL (US); Bindu Rama Rao, Laguna Niguel, CA (US)

(72) Inventors: Christopher C. Winslade, Chicago, IL (US); Bindu Rama Rao, Laguna Niguel, CA (US)

(73) Assignee: ENPULZ, LLC, Chicago, IL (US)

(21) Appl. No.: 13/471,373

(22) Filed: May 14, 2012

Related U.S. Application Data
(60) Provisional application No. 61/507,928, filed on Jul. 14, 2011.

(51) Int. Cl. G06Q 30/06; G06Q 30/02

(52) U.S. Cl. 705/14.4; 705/26.2

(57) ABSTRACT

A system and method for providing a demand driven promotion system supporting social networking and searching, substantially as shown in and/or described in connection with at least one of the figures, as set forth more completely in the claims.

### CROSS-REFERENCE TO PRIORITY APPLICATION

The present U.S. Utility patent application claims priority pursuant to 35 U.S.C. §119(e) to pending U.S. Provisional Patent Application Ser. No. 61/507,928, filed Jul. 14, 2011, entitled “DEMAND DRIVEN PROMOTION SYSTEM SUPPORTING SOCIAL NETWORKING AND SEARCHING,” the contents of which is hereby incorporated herein by reference in its entirety and made part of the present U.S. Utility patent application for all purposes.

### CROSS REFERENCE TO RELATED APPLICATION

The present application is related to co-pending U.S. Utility application Ser. No. 13/397,825 filed Feb. 16, 2012, which is incorporated herein by reference in its entirety for all purposes.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Present systems are generally designed for a seller-dominated sales model and fail to take advantage of various aspects of social networking systems.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for providing a demand driven promotion system supporting social networking and searching. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 shows a non-limiting example of a personal (or user) consumer interface, in accordance with various aspects of the present invention.

FIG. 2 shows a non-limiting example of a buyer group definition interface, in accordance with various aspects of the present invention.

FIG. 3 shows a non-limiting example of a buyer group interface, in accordance with various aspects of the present invention.

FIG. 4 shows a non-limiting example of a seller interface, in accordance with various aspects of the present invention.

FIG. 5 shows a non-limiting example of a buyer group portion of a seller interface, in accordance with various aspects of the present invention.

FIG. 6 shows a flow diagram of a non-limiting exemplary method for managing buyer group activity, in accordance with various aspects of the present invention.

FIG. 7 shows a flow diagram of a non-limiting exemplary method for managing buyer group formation and purchase, in accordance with various aspects of the present invention.

FIG. 8 shows a flow diagram of a non-limiting exemplary method for forming a buyer group (e.g., an ad-hoc buyer group), in accordance with various aspects of the present invention.

FIG. 9 shows a flow diagram of a non-limiting exemplary method for managing seller activity, in accordance with various aspects of the present invention.

FIG. 10 shows a block diagram of a non-limiting exemplary system for managing buyer group and/or seller activity, in accordance with various aspects of the present invention.

FIG. 11 shows a diagram of a non-limiting exemplary data structure environment that may be utilized for managing buyer group activity, in accordance with various aspects of the present invention.

FIG. 12 shows a diagram of a non-limiting exemplary data structure environment that may be utilized for managing seller activity, in accordance with various aspects of the present invention.

FIG. 13 shows a diagram of a non-limiting exemplary environment in which buyer group and/or seller activity may be managed, in accordance with various aspects of the present invention.

FIG. 14 shows a diagram of an overall on-line sales environment supporting various buyer group management implementations, in accordance with various aspects of the present invention.

FIG. 15 shows a diagram of a searching environment, in accordance with various aspects of the present invention.

FIG. 16 shows a diagram of a promotion server searching environment, in accordance with various aspects of the present invention.

### DETAILED DESCRIPTION OF VARIOUS ASPECTS OF THE INVENTION

The following discussion will refer to various modules, components, and/or circuits. Such modules, components, and/or circuits may generally comprise hardware and/or a combination of hardware and software (e.g., including firmware). Such modules may also, for example, comprise a computer readable medium (e.g., a non-transitory medium) comprising instructions (e.g., software instructions) that, when executed by a processor, cause the processor to perform various functional aspects of the present invention. Accordingly, the scope of various aspects of the present invention should not be limited by characteristics of particular hardware and/or hardware/software implementations of a module, component or circuit unless explicitly claimed as such. For example and without limitation, various aspects of the present invention may be implemented by one or more processors (e.g., a microprocessor, digital signal processor, baseband processor, microcontroller, etc.) executing software instructions (e.g., stored in volatile and/or non-volatile memory). Also for example, various aspects of the present invention may be implemented by an application-specific integrated circuit (“ASIC”) and/or other hardware components.

Additionally, the following discussion will refer to various functional modules (e.g., communication modules, signal processing modules, etc.). It should be noted that the following discussion of such various modules is segmented into such modules for the sake of illustrative clarity. However, in actual implementation, the boundaries between various modules may be blurred. For example, any or all of the functional modules discussed herein may share various hardware and/or software components. For example, any or all of the functional modules discussed herein may be implemented wholly or in-part by a shared processor executing software instructions. Additionally, various software sub-modules that may be executed by one or more processors may be shared between various software modules. Accordingly, the scope of various aspects of the present invention should not be limited by arbitrary boundaries between various hardware and/or software components, unless explicitly claimed.

The following discussion may also refer to communication networks and various aspects thereof. For the following discussion, a communication network is generally the communication infrastructure through which a device (e.g., a portable communication device (such as, e.g., a smart phone or tablet computer), computer, television, television control device, television provider, television programming provider, television receiver, video recording device, set top box, network controller, satellite dish circuitry, server, etc.) may communicate with other devices. For example and without limitation, a communication network may comprise a cable and/or satellite television communication network, a cellular communication network, a wireless metropolitan area network (WMAN), a wireless local area network (WLAN), a wireless personal area network (WPAN), any home or premises communication network (e.g., an in-home coaxial cable television communication network), etc. A particular communication network may, for example, generally have a corresponding communication protocol according to which a communication device may communicate with the communication network. Unless so claimed, the scope of various aspects of the present invention should not be limited by characteristics of a particular type of communication network.

The following discussion will generally refer to consumer products. Such products include consumer goods and/or services. For example, a group purchase of a consumer product may result in the delivery of a consumer good to each of the buyers in the buyer group. Also for example, a group purchase of a consumer product may result in the provision of service vouchers (or coupons) to the buyers in the buyer group. Such products may also include, for example, promotions such as, for example, prepaid credit cards, gift cards, store credits, coupons, vouchers, rebates, discounts, a percentage off, buy one get one free, buy one get one half off, buy ten get the eleventh free, advertisements, etc.

Various aspects of the present invention generally comprise presenting (e.g., via the Internet) a consumer/buyer networking system to consumers. For example, various aspects provide a virtual forum in which consumers can aggregate their purchasing power to purchase consumer products (goods and/or services) in bulk at reduced bulk-rate prices. In other words, by aggregating demand for a given consumer product, a group can effectively drive the cost down for the give consumer product as compared to what the cost would be if the individuals in the group were acting alone.

For example, a plurality of consumers can form a buyer group (or consumer group) associated with the purchase of a specific consumer good and/or service and/or of a specific set of consumer goods and/or services. Such a buyer group may be referred to herein as an ad-hoc buyer group. The buyer group may, for example, exist for only a single consumer product transaction. Additionally for example, the buyer group may exist for a multi-product transaction (e.g., related or unrelated products). The buyer group may also, for example, exist for a repeating consumer product transaction (e.g., repeated purchases of consumable products, regularly scheduled and/or on-demand).

Various aspects of the present invention may then broker a deal with one or more suppliers of the desired consumer product(s). For example, various aspects of the present invention provide for locating a supplier willing to meet a buyer group's terms, providing a communication interface by which a buyer group and seller may negotiate (e.g., regarding price, group size, shipping details, and/or any of the deal factors discussed herein), identifying a lowest-cost supplier, etc.

Various aspects of the present invention may also provide financial coordination for a particular transaction, for example performing financial operations as a financial go-between between a buyer group and a seller. Such financial coordination may, for example, comprise maintaining an escrow account (or, for example, interfacing with a third party performing such a role), serving as an agreed-upon intermediary for financial disputes between a buyer group and seller, etc.

Various aspects of the present invention may also, for example, comprise providing tracking mechanisms that allow buyer group members and/or sellers to monitor performance of a consumer product transaction (e.g., tracking product production, shipping, delivery, etc.).

Various aspects of the present invention may additionally, for example, comprise managing receipt of monies for the performance of various activities described herein from the sellers, buyers, and/or third parties (e.g., receiving a broker commission, receiving a finder's fee, receiving monies for operating as a financial intermediary, receiving monies for operating as a dispute mediator, etc.). Also for example, various aspects of the present comprise presenting advertising (e.g., targeted advertising), and collecting revenue for presenting such advertising.

Various aspects of the present invention may, for example, comprise a system operating to perform any of a variety of interface functions related to group purchasing of consumer goods and/or services, non-limiting examples of which will now be provided.

For example, various aspects of the present invention may provide for the registration of users. For example, the system may provide for registration of new users (i.e., generation of a user profile), modification of existing user profiles, elimination of users from the system, etc. For example, the system may operate to (e.g., including operate when enabled to) set up user account. Such operation may comprise providing a user interface by which the system may interact with a user to set up one or more user accounts for the user.

For example, the system may provide a user interface template in which a user may input personal information (e.g., identification information, product interest information, financial information, address and/or location information, contact information, etc.). Due to the sometimes sensitive nature of consumer transactions, user identification information may include an alias (e.g., to mask the purchase of expensive merchandise). Additionally, the user profile may include multiple portions, each having different levels of security. For example, a user profile may have a personal information or confidential portion (e.g., financial information such as, for example, credit, credit card, account, etc., information, address and/or location information, contact information, etc.), that is only shared by the user as necessary in connection with a secure transaction. Another portion may be a “friends and family” or social group portion, including information (such as, e.g., contact information, address and/or location information, etc.) that is made available to other known and trusted users or social group members, but not to the public in general. A further portion may be a commercial portion (product interests, technology interests, buyer group memberships, preferred sellers, preferred manufacturers, etc.), that is shared with the public in general (e.g., any commercial entity, user, etc.), and which may be automatically updated based on user interaction history, for purposes of driving promotions and buyer group transactions. In one embodiment, the user may determine what information is shared within any given security level or profile portion. In one embodiment, the user may also decide whether the user desires to enable automatic updating of the user profile based on user interaction. In another embodiment, the enabling and performance of user profile updating is transparent to the user.

The system may, for example, provide a user interface by which the system may obtain from the user information regarding the user's interests in consumer products (e.g., goods and/or services). As an example, the system may provide a user interface by which the user may indicate general product interests. For example, the user may specify an interest in particular goods and/or services. The system may then, for example, provide for user modification of such product interests over time, as the user's immediate and/or general product interests change.

The system may, for example, utilize such product-interest information to notify a user (e.g., on a web page, via text message, via email, via a mobile application, via social networking outlets such as Facebook™ or Twitter™, etc.) when a buyer group is being formed for purchasing a type of product that is potentially of interest to the user. For example, in an exemplary scenario in which a user has specified an interest in televisions, the system may notify the user of existing buyer groups and/or new buyer groups that have been formed for a television purchase.

Also for example, the system may utilize such product-interest information to notify a user of interest groups that are generally interested in particular goods and/or services. For example, in an exemplary scenario in which a user has specified an interest in televisions, the system may notify the user of existing product interest groups that have been formed for general discussion of television products, vendors, etc.

In an exemplary implementation that provides notifications to the user (e.g., notifications discussed herein), the system may provide for user-specification of specific types of products for which the user desired such notifications.

Alternatively to, and/or in addition to, a user interface-based approach to obtaining product-interest information from a user, the system may automatically (i.e., without requiring additional user input) analyze user activities (e.g., purchasing activities, discussion activities, etc.) to ascertain the user's interests. As discussed above, the system may then analyze such automatically-generated product-interest information to determine whether to notify the user of buyer group and/or interest group activities that might be of interest to the user.

The system may, for example, operate to (e.g., including operate when enabled to) obtain user financial information (e.g., by providing a user interface to the user for entry of such information, etc.). The system may, for example, maintain a record of such information for the user's convenience when performing purchases. Also, the system may provide a user interface by which the user may input financial transaction information (e.g., account information, money wire information, credit card information, debit card information, etc.) for a single purchase. In a single-purchase scenario, upon completion of the particular financial transaction for which the financial information was acquired, the system may purge such financial information from the system.

In an exemplary implementation including a system that is linked with (e.g., communicatively coupled with) other systems comprising user information (e.g., a social networking system, a financial institution system, etc.), the system may obtain some or all of the desired user information automatically from such other system(s). For example, the system may query the user to gain permission to import desired user information from other systems with which the system is communicatively coupled.

Note that any or all of the functionality discussed herein may be implemented by an independent system (e.g., generally or exclusively formed for implementing the functionality discussed herein) and/or may be implemented as part of another system (e.g., a social networking system). For example, a social networking system (e.g., Facebook™ or Twitter™) may be enhanced to include all or some of the functionality discussed herein. In such a scenario, the desired user information (or at least some of the desired user information) may already be available to the consumer purchase portions of such an aggregate system. In addition, a supply driven coupon system (e.g., Groupon™ or Living Social™) may be enhanced to include all or some of the functionality discussed herein

As another interface example, various aspects of the present invention may provide users a personal consumer interface. Such personal consumer interface may, for example, be implemented on a web page dedicated to such interface, a consumer-related portion of another interface (e.g., a consumer-related portion of a social networking web page, etc.). The discussion herein generally mentions web pages as potential interfaces for various aspects of the present invention. Such mention is merely illustrative, for example providing an exemplary implementation that might be of use in an Internet-based system, and non-limiting. For example, when this discussion mentions a web page being provided to the user and providing particular information and/or functionality, such information and/or functionality may also be provided by an application-based user interface screen that is independent of the World Wide Web (e.g., generated by a local software program or application residing on the user's personal computer, personal communication device, etc.).

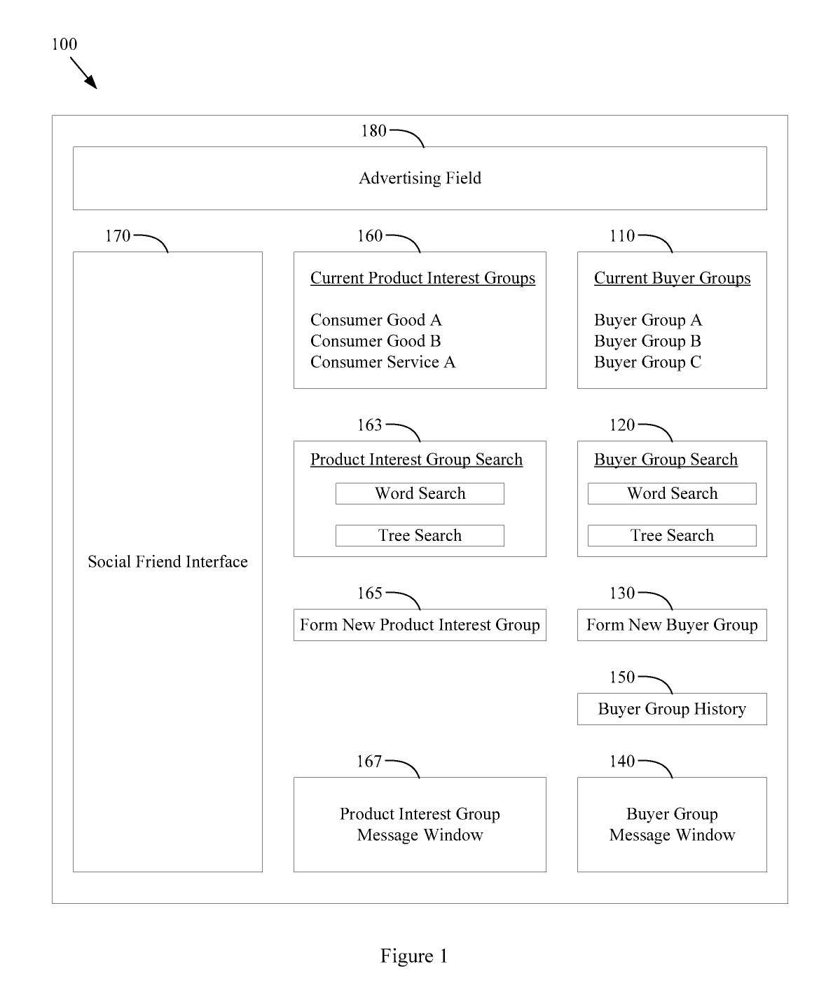

FIG. 1 provides a non-limiting example of a personal (or user) consumer interface 100, in accordance with various aspects of the present invention. The exemplary consumer interface 100 illustrated in FIG. 1 and discussed herein is presented for illustrative purposes only and is non-limiting. Accordingly, the scope of various aspects of the present invention should not be limited by any characteristics of the exemplary consumer interface 100 unless explicitly claimed.

A consumer interface 100 (e.g., a web page or application) may provide a list of buyer groups of which the user is presently a member. For example, an exemplary list is illustrated at item 110 of FIG. 1. Such an exemplary buyer group list 110 may, for example, comprise links (e.g., hyperlinks) to respective web pages comprising information associated with each buyer group. For example, a later discussion will present various aspects of such a buyer group interface (or buyer group page). User-selection of a buyer group in the buyer group list 110 presented to the user may, for example, result in a user interface for the selected buyer group being presented to the user. Such a buyer group list 110 may, for example, be presented to a user on a consumer interface 100 or may, for example, be superimposed over any type of web page (e.g., a general-purpose web page, manufacturer web page, distributor web page, etc.).

The exemplary buyer group list 110 may, for example, provide the ability for the user to modify group membership (e.g., join a group, opt out of a group, etc.). As a non-limiting example, a user may (e.g., with a mouse or touch pad or via a touch screen) select a listed buyer group, and in response to such a selection, the system may present the user with options to quit the selected group, join the selected group, remove the selected group from the buyer group list 110, etc.

In the buyer group list 110, each buyer group may have one or more visual indications (e.g., textual indication, graphical feature, color, etc.) associated therewith to indicate general transaction status. For example, each buyer group may be listed with quick-glance transaction status summary information showing high-level status of the buyer group and/or the consumer product transaction associated therewith (e.g., presently building the group, presently seeking seller (or supplier), seller located and waiting for final buyer commitment and/or fund transfer, supplier preparing shipment, products shipped and in-route, products delivered, etc.). Note that the system may also communicate a personal message to the user when a status changes (e.g., notifying the user upon completion of buyer group formation, upon identification of a seller, upon establishment of mutually agreeable terms (or closing a deal) with a seller, upon shipment of a product, upon a counteroffer being received from a seller, etc.).

A consumer interface 100 (e.g., a web page or application) may, for example, provide a searching interface with which the user may find presently existing buyer groups (e.g., buyer groups of which the user is not presently a member). For example, an exemplary buyer group searching interface is illustrated at item 120 of FIG. 1. A system implementing various aspects of the present invention may, for example, comprise a database of buyer groups that have been formed. Such a database may, for example, be centralized or distributed between a plurality of sites (e.g., regional sites).

An exemplary buyer group searching interface 120 may, for example, comprise a search field for entering search criteria that provides the user the capability to search for a buyer group based on any of a variety of buyer group search criteria (e.g., search words, terms, images, queries, logical combinations thereof, etc.). For example, the buyer group searching interface 120 may provide the ability for the user to search for a buyer group based on any one or more of: a specific product, a product type, a geographical area, a seller, a buyer group purchase status (e.g., pre-purchase for groups that have not yet finalized a sales contract, pre-shipment for potentially joining a group at a later stage, etc.), etc. The buyer group searching interface 120 may, for example, provide for user-specification of logical search combinations by which the user may specify any one or more of a plurality of search criteria.

Also for example, the buyer group searching interface 120 may provide for buyer group searching based on a nested (or tree) structure. For example, in a non-limiting exemplary scenario, a user may select a geographical region (e.g., county, city, metropolitan area, state, etc.) from a list of geographical regions presented to the user by the buyer group searching interface 120 and be presented with buyer groups (and, for example, links to respective interfaces (e.g., web pages) associated with such buyer groups) associated with the selected geographical region. In another exemplary scenario, a user may select a product type (e.g., television, wine, computer, telephone, prepaid credit card, gift card, soda, etc.) from a list of product types presented to the user by the buyer group searching interface 120 and be presented with buyer groups (and, for example, links to respective interfaces (e.g., web pages) associated with such buyer groups) associated with the specified product type. For example, a user may specify “television” (or a specific type of television) and be presented with a list of buyer groups (or links associated therewith) that have been formed for the purchase of televisions (or the specific type of television). Also for example, a user may specify “gift card” (or a gift card for a particular type of store) and be presented with a list of buyer groups (or links associated therewith) that have been formed for the purchase of gift cards. In this example, the buyer group may commit a certain dollar amount for the gift cards in exchange for a discount (e.g., pay $90 for a $100 gift cards). In other words, a buyer group may be formed to solicit promotions from sellers that are related to goods and/or services or goods and/or services categories, or that are independent of any specific goods and or services or goods and/or services categories.

Additionally for example, the buyer group searching interface 120 may comprise an interface by which the user may input filtering information. For example, using such an interface, a user may specify an interest only in buyer groups in the Chicago metropolitan area. Also for example, a user may specify an interest only in buyer groups looking for to-the-door delivery of an ordered item as opposed to a drop shipment to a central location. Additionally for example, a user may specify an interest only in buyer groups that specify billing after successful receipt of product (as opposed to pre-pay, half-up-front, etc.). Further for example, a user may specify an interest only in buyer groups of at least a minimum size.

Alternatively, or additionally, a user may specify search criteria in a general-purpose search interface (e.g., Google™, Yahoo™, Bing™, etc.) or in the searching interface 120 for specific products (i.e., goods and/or services), and the system can automatically identify (e.g., by searching a buyer group database, the Internet, etc.) and present related buyer groups that have either already been formed or are being formed. Such identification may be based on the search criteria being used, or on the results of the search. In other words, the search criteria can be concurrently used to search the Internet for desired products, and to also search a buyer group database or the Internet for buyer groups presumably related to the desired products. In one embodiment, the search criteria used for the general-purpose search interface is automatically used to “populate” the searching interface 120 and launch a search for applicable or related buyer groups. Likewise, the search criteria used for the searching interface 120 is automatically used to “populate” the general-purpose search interface and launch a search for applicable or related buyer groups. Alternatively (or additionally), the search criteria can be used to search the Internet for desired products (i.e., goods and/or services), and once the user specifies those products in which the user is interested (e.g., by selecting a visual object, such as a pictorial or graphical image, or text associated with those products, by selecting (e.g., selecting a hyperlink) and viewing information about those products, navigating to a web page associated with those products, placing those products in a shopping cart, etc.), information regarding the selection (e.g., information regarding specified products (e.g., type of good and/or service), a category or categories related to specified products or in which the specified products are found, complementary products, competitive products, etc.) is used to search a buyer group database or the Internet for buyer groups related to the desired products.

In an exemplary scenario, a user may select (e.g., right-click) a photograph of a desired product on a current web page. In response to such a right-click, the system may then present an action list to the user (e.g., superimposed over the current web page), where the action list comprises a user-selectable option to search for buyer groups associated with the selected product. Upon user-selection of the buyer group search option, the system may then search for currently-existing buyer groups that have been formed for the purpose of purchasing the selected product. Additionally, the action list may also comprise a user-selectable option for the user to form a new buyer group.

These approaches may also be at least partially combined or tiered. Specifically, when a user searches for products (i.e., goods and/or services) via the Internet, the same search criteria used for such searching may also be used to search a buyer group database or the Internet to identify buyer groups presumably related to the desired products. If the buyer specifies interest in specific products (e.g., by selecting and viewing information about those products, placing those products in a shopping cart, etc.), another follow-up search may be performed to provide a more robust identification of buyer groups. Alternatively (or additionally) a filter may be applied to results of the initial identification to narrow or identify a subset of the results, based on the user specified interest in specific products. The filtering criteria may automatically be determined by the system or manually entered by the user. In either case, the criteria may include, for example, information regarding specified products (e.g., type of goods and/or services), a category or categories related to specified products or in which the specified products are found, complementary products, competitive products, etc. Also, these approaches can all be performed automatically without user interaction, or involve some prompting by the user. For example, after initial buyer group identification results are presented to the user, the system may ask the user whether another search or filtering of the results is desired.

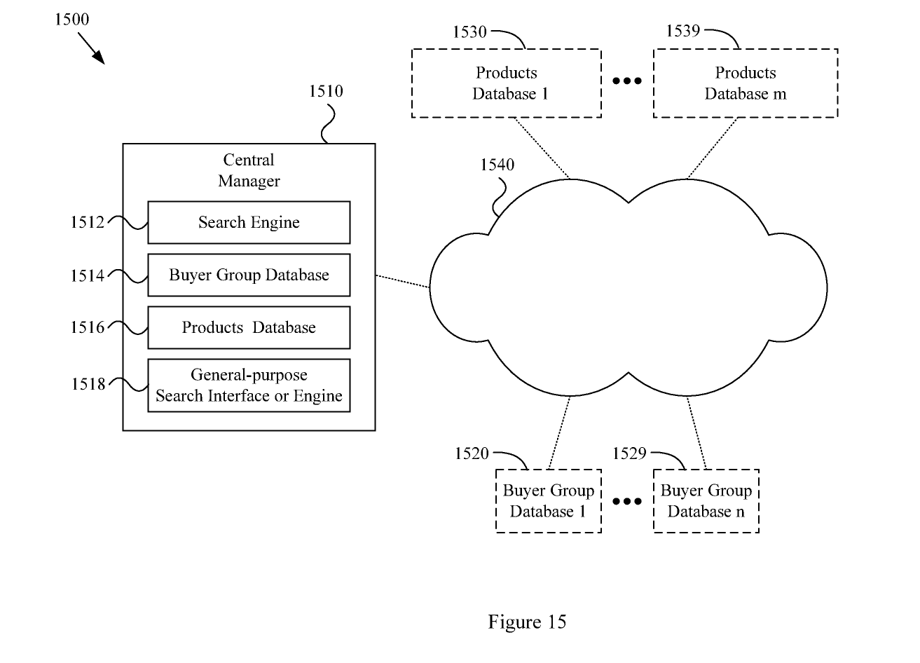

FIG. 15 shows a diagram of a searching environment 1500 in accordance with various aspects of the present invention. The exemplary environment 1500 shows a central manager 1510. As will be discussed in more detail later, the central manager 1510 may be located and operated as its own site, located at a seller site, a buyer site, an intermediary site, etc. The exemplary central manager 1510 may comprise or support a search engine 1512 (e.g., a local search engine) that conducts a search of a local buyer group database 1514 (e.g., without communicating over a wide area network, such as the Internet) for buyer group information and/or a search of a product database 1516 for product (i.e., goods and/or services) information. The central manager 1510 may also comprise or support a general purpose search interface or engine 1518 (e.g., a 3^{rd}-party general-purpose Internet search interface or engine, like Google™, Yahoo™, Bing™, etc.) that searches a network of databases for buyer group and/or product information. For example, the exemplary environment 1500 shows n (an integer number) exemplary buyer group databases at items 1520-1529 and m (an integer number) exemplary product databases at items 1530-1539. The central manager 1510 (e.g., the general-purpose search interface or engine 1518) is communicatively coupled to such databases 1520-1529 and 1530-1539 via one or more communication networks 1540 (e.g., the Internet, a local area network, a wide area network, a metropolitan area network, etc.). The general-purpose search interface or engine 1518 may, for example, operate to (e.g., including operate when enabled to) search any or all of the buyer group databases 1520-1529 and the product databases 1530-1539. As discussed above, operation of the search engine 1512 and the general-purpose search interface or engine 1518 may be coordinated (e.g., for concurrent searching using the same or similar search criteria, for serialized searching, etc.).

Now referring back to FIG. 1, to facilitate quick searching for buyer groups, the searching interface 120 provides a drop down or pull down menu in connection with a search field where product search criteria is entered, listing the buyer groups associated with the search criteria entered. For example, if “television” is typed in the search field, a drop down or pull down menu is presented listing all or some portion of buyer groups related to “televisions”, which then can be selected via the drop down or pull down menu.

Additionally, to facilitate quick searching for buyer groups, the system can enable swipe searching functionality to enable identification of related buyer groups. Specifically, while a user is generally searching for various products (either by use of the searching interface 120 or typical search interfaces (e.g., Google™ or Yahoo™ or Bing™), when the user identifies a particular product of interest on the screen, the user can highlight text on the screen regarding or associated with the particular product of interest. Then, the user can right click on the highlighted text and select a search option asking whether the user is interested in identifying or searching for buyer groups associated with or corresponding to the subject matter of highlighted text. Once selected, the search is automatically performed and relevant buyer groups are presented to the user for possible selection. Alternatively, the search can be performed automatically on some action (e.g., right click or simply on the highlighting itself), without asking whether the buyer is interested in identifying or searching for buyer groups.

In addition to (or as an alternative to) performing searching via a searching interface, to facilitate location of a buyer group for particular products and/or services by a user, the system provides via the consumer interface 100 buyer groups organized into different categories (and sub-categories, where appropriate) based on, for example, products and/or services. This enables the user to browses through the categories and sub-categories of products and/or services to locate and select one or more corresponding buyer groups. The system may also categorize buyer groups based on other criteria, such as by, for example, manufacturers, sellers, service providers, best rated products and/or services, most popular products and/or services, best rated manufacturers and/or sellers, etc.

In addition (or as an alternative), the system provides via the consumer interface 100 products and/or services organized into different categories (and sub-categories, where appropriate). The user can then identify products and/or services of interest and select them, and a search is performed for related buyer groups. The system may also have pre-identified buyer groups stored and associated with specific products and/or services or with the categories and subcategories of products and/or services, so that selection of a given product, service, category or sub-category immediately presents in a pop-up window or bubble, for example, an identification of buyer groups associated with the given product, service, category or sub-category corresponding to the selection. Also, for even quicker identification, the system can present associated buyer groups in a pop-up window or bubble as the user moves his or her curser, for example, over the product, service, category or sub-category presented on the screen. Similarly, links to third party websites can have associated buyer group information, so that when a user selects a link to a product of a third party, the related buyer group information is automatically presented to the user along with the third party web page corresponding to the product.

Also, to further facilitate quick searching for buyer groups, the system can enable context based auto-searching for buyer groups. Specifically, when a user is viewing a particular screen or pulls up a particular web page, the system can scan, e.g., text, images, videos, links, etc. on the screen or web page to identify one or more products and/or services found or advertised on the screen or web page, and use the products and/or services identified (or information related thereto, such as, e.g., the text, video information, image information, links or link information, etc.), to search for related buyer groups. The system then caches buyer group identification information so it is ready for presentation when the user performs some sort of action indicating interest in the product (e.g., highlights associated text, selects a link, clicks on an image, plays a video, etc.). This also enables pre-screening by the user of relevant buyer groups, which can be presented in a pop-up window or bubble as soon as the user moves his or her cursor over information identified as related to a given buyer group (e.g., the text, images, videos, links, etc.) on the screen or web page, for example.

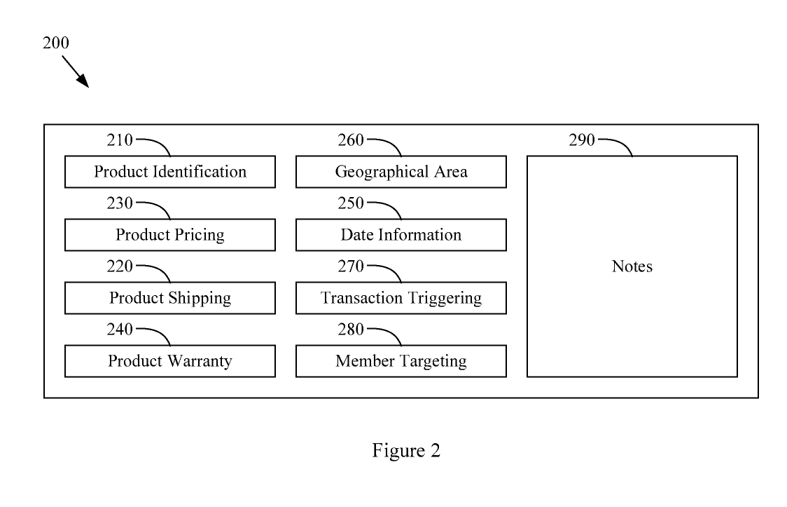

A consumer interface 100 (e.g., a web page or application) may, for example, provide a buyer group definition interface with which the user may define (or form) a new buyer group (or a link to such an interface). For example, item 130 at FIG. 1 shows a user-selectable graphical button 130 (or other feature, for example, a hyperlink) on a GUI that, when selected, will initiate a buyer group definition interface. Such an interface may be presented to the user on a user interface (e.g., an interface page) that is dedicated exclusively or in-part to the definition of a buyer group. Such an exemplary buyer group definition interface is illustrated at FIG. 2.

Turning to FIG. 2, such figure shows a non-limiting example of a buyer group definition interface 200, in accordance with various aspects of the present invention. The exemplary buyer group definition interface 200 illustrated in FIG. 2 and discussed herein is presented for illustrative purposes only and is non-limiting. Accordingly, the scope of various aspects of the present invention should not be limited by any characteristics of the exemplary buyer group definition interface 200 unless explicitly claimed.

The buyer group definition interface 200 (e.g., provided on one or more GUI screens) may, for example, provide for user-specification of the consumer product (good and/or service) for a proposed purchase. For example, the buyer group definition interface 200 may comprise a product specification (or identification) interface 210 by which the user may search by product type, manufacturer, etc., selecting the desired product. In a non-limiting exemplary scenario, the user may select “consumer electronics” from a list of product categories provided to the user by the interface 210 and be presented with a list of consumer electronics types. Continuing the exemplary scenario, the user may then select “television” from the presented list of consumer electronic types and be presented with a list of television manufacturers and/or specific models of televisions, etc. Continuing the exemplary scenario, the user may then select the exact television of interest for the group purchase. Note that specificity of the exact television model is not a necessity. For example, a user may specify a particular general type of television (e.g., 50-inch LED television) for purchase.

The buyer group definition interface 200 may also, for example, provide for user specification of shipping details for the proposed purchase. For example, the buyer group definition interface 200 may comprise a product shipping interface 220 by which the user may input (e.g., by selection from a list presented to the user) a manner in which the purchased product is to be delivered to the buyer group (or individual members thereof). The product shipping interface 220 may provide for user-specification of any of a variety of different types of shipping, non-limiting examples of which will not be provided.

For example, utilizing the product shipping interface 220, the user may specify that each of the proposed products be individually shipped to each purchaser (member of the buyer group). Also for example, the user may specify a specific type of delivery (e.g., first class mail, overnight, sign-for-release, two-day delivery, particular carrier, etc.). Additionally for example, the user may specify that the entire shipment of products be shipped to a single location (e.g., a participating warehouse, etc.). Such specification may, for example, reduce overall cost of the purchase in exchange for customer pick-up at a centralized location. Further for example, the user may specify that the user group will arrange for pick-up and delivery of the product to the members of the group (e.g., by a third party shipping company).

The buyer group definition interface 200 may also, for example, provide for user specification of pricing for the proposed purchase. For example, the buyer group definition interface 200 may comprise a product pricing interface 230 by which the user may input pricing for the proposed purchase. For example, the user may specify an exact price (base price, shipping price, total end-to-end price, etc.) for the purchase. In such a scenario, the user may indicate that the first seller to meet the desired terms gets a sales contract. Also for example, the user may specify a maximum price and direct the system to find the lowest price provider (e.g., brokering the sale to the lowest-cost seller, a lowest-cost approved seller, a lowest-cost seller meeting at least a particular minimum level of customer satisfaction rating, etc.). Additionally for example, the user specify “lowest available price” and specify that buyers in the group get to back out if the lowest found price is too high.

The buyer group definition interface 200 may also, for example, provide for user specification of product warranty provisions for the proposed purchase. For example, the buyer group definition interface 200 may comprise a product warranty interface 240 by which the user may input warranty requirements for the proposed purchase. For example, when the user specifies a product, the manufacturer warranty information may be presented to the user. The user can then either approve the standard warranty or specify different warranty provisions. Also for example, in an exemplary scenario in which a wholesaler is the seller, the wholesaler may have its own warranty provisions in addition to the manufacturer's provisions (strict or flexible) that may apply to the sale.

The buyer group definition interface 200 may also, for example, provide for user specification of controlling dates for the proposed purchase. For example, the buyer group definition interface 200 may comprise a date interface 250 by which the user may input controlling date information for the proposed purchase. For example, the date interface 250 may provide for user-specification of a latest transaction completion date. In an exemplary scenario, the user forming the buyer group may specify a date by which the buyer groups purchase offer must be accepted by a seller (e.g., a purchase contract completion date). Also for example, the date interface 250 may provide for user-specification of a latest delivery date. In another exemplary scenario, the user forming the buyer group may specify a date by which a purchased product must be delivered to the buyers (e.g., with a contractual termination clause, a financial penalty clause, etc.).

Also for example, the date interface 250 may provide for user specification of a life time duration for the buyer group. In an exemplary scenario, the user forming the buyer group may specify a date by which the buyer group will cease to exist. As mentioned previously, the buyer group might only exist for the duration of one purchase. The system may comprise a default group expiration time and/or a maximum group expiration time, but the user forming the buyer group may also specify a termination date or duration. For example, the user may specify a duration of one month, after which the group may be disbanded (e.g., due to lack of interest on the buyer and/or seller side).

The buyer group definition interface 200 may also, for example, provide for user specification of geographical area for the proposed purchase. For example, the buyer group definition interface 200 may comprise a geographical area interface 260 by which the user may input geographical area information for the proposed purchase. For example, a user may specify a particular geographical area for a proposed product purchase, which may be beneficial for controlling shipping costs. In an exemplary scenario, a user may form a buyer group that saves shipping costs by specifying a bulk shipment of product to a single location, a plurality of specified central locations, a plurality of locations in a particular geographical area, etc.

The buyer group definition interface 200 may also, for example, provide for user specification of triggering conditions. For example, the buyer group definition interface 200 may comprise a transaction triggering interface 270 by which the user may input triggering conditions for particular aspects of the proposed product purchase.

For example, the transaction triggering interface 270 may provide for user specification of conditions (e.g., group membership total) that will cause the system to begin seeking a seller. For example, the user forming the group may specify that the system refrain from seeking a seller until a particular number of buyers have committed to the purchase. In an exemplary scenario, the user forming the buyer group may specify that the system wait until at least a thousand users join the group before the system presents the purchase offer to sellers (e.g., on a take-it-or-leave-it basis, soliciting counter-offers, etc.).

Also for example, the transaction triggering interface 270 may provide for user specification of conditions (e.g., price conditions, lowest-priced provider found, date conditions, etc.) that will cause the system to accept a seller's offers, for example signifying formation of a purchase contract. In an exemplary scenario, the user may specify that the system automatically (i.e., without additional user interaction) form a contract with a seller that accepts all of the terms of the buyer group. In another exemplary scenario, the user may specify that the system contact the group administrator (e.g., founding user) of the buyer group (or all members of the buyers group) for final approval of a deal.

The buyer group definition interface 200 may also, for example, provide for user specification of users or groups thereof as potential members of the group. For example, the buyer group definition interface 200 may comprise a member targeting interface 280 by which the user may identify potential members for the group. For example, the member targeting interface 280 may for user specification (or targeting) of other individual users or other groups of users (e.g., by identifying particular product interest groups) that are to be notified by the system of the newly formed (or modified) buyer group. In an exemplary scenario in which a group administrator forms a group for the purchase of laptop computers, the administrator may specify (e.g., by selecting from a pull down list provided to the user by the interface 280, by traversing and selecting from a tree structure search provided to the user by the interface 280, by utilizing word search capability provided to the user by the interface 280, etc.) that various product interest groups with a known interest in computer products be notified of the group formation.

The buyer group definition interface 200 may also, for example, provide for user (e.g., group administrator) communication of notes to the buyer group. For example, the buyer group definition interface 200 may comprise a notes interface 290 by which the user may communicate or post messages to the buyer group. Such notes may, for example, comprise messages regarding group goals, transaction status, counter-offers received from sellers, etc.).

The buyer group definition interface 200 may, for example, comprise a template type of interface in which the template is presented to the user and the user addresses each field with a field-specific interface. Also for example, such an interface 200 may comprise a type of interface that walks the user step-by-step through the buyer group definition process.

The previous discussion provided non-limiting examples of various types of information with which a buyer group might be defined. A buyer group may be defined by one or more types of information. For example, in a first exemplary scenario a user might provide product identification information, purchase term information, shipping information, date information, user group size information, and warranty information. A buyer group may then be defined based, at least in part, on such information. Also for example, in a second exemplary scenario a user might only provide product identification information. A buyer group may then be defined (at least initially) based only on the product identification information. In such an exemplary scenario, one or more potential sellers may interact with the buyer group (e.g., an administrator thereof) to propose and negotiate all of the remaining purchase terms.

In general, the buyer group definition interface 200 may comprise any of a variety of characteristics, non-limiting examples of which are presented above. Accordingly, the scope of various aspects of the present invention should not be limited by any characteristics of examples presented herein unless explicitly claimed.

Returning to FIG. 1, the consumer interface 100 (e.g., a web page or application) may, for example, provide a buyer group message interface with which the user may communicate or post messages concerning buyer groups (e.g., concerning buyer groups of which the user is a member, of which the user has specified an interest in, etc.). For example, item 140 at FIG. 1 shows a buyer group message interface (e.g., a message window) by which information of existing buyer groups may be presented to the user in an unsolicited manner. Such a buyer group message interface 140 may comprise any of a variety of characteristics (e.g., characteristics of a repeating scrolling list, scrolling banner, ticker, etc.).

For example, a system implementing various aspects of the present invention may analyze a user profile (either explicitly formed by the user and/or formed based on user interaction or purchase activity) to identify present buyer groups in which the user might be interested. The buyer group message interface 140 may present information of such identified buyer groups to the user (e.g., in a solicited and/or unsolicited manner). Also for example, the system may identify buyer groups in which “buyer friends” (e.g., individuals identified by the user as having common buying interests) or “social friends” (e.g., individuals identified by the user as social friends, for example in a social network) are participating, and the buyer group message interface 140 may present information of such identified buyer groups to the user. In an exemplary scenario, the buyer group message interface 140 may present a scrolling list or banner of potential buyer groups of interest, which may then be selected by the user to cause the system to present more detailed information of a selected buyer group to the user.

The consumer interface 100 (e.g., a web page) may, for example, provide a buyer group history interface with which the user may store, retrieve, and/or review information regarding prior commercial transactions. For example, item 150 at FIG. 1 shows a buyer group history interface by which information of prior buyer group commercial transactions may be presented to the user and/or received from the user. Such a buyer group history interface 150 may comprise any of a variety of characteristics.

For example, the buyer group history interface 150 may comprise a user interface by which the user can enter information associated with a buyer group purchase (e.g., lessons learned, sellers to avoid, buyers to avoid, shipping experiences, warranty experiences, product quality information, etc.). Also for example, the buyer group history interface 150 may comprise an interface whereby a user can retrieve and review the details of previous purchases, including product details, financial details, group details, and can further review comments offered by other group participants.

The consumer interface 100 (e.g., a web page) may, for example, provide one or more friend interfaces with which the user may perform social networking. For example, item 170 at FIG. 1 shows an exemplary social friend interface by which the user may communicate with designated friends. A friend interface may comprise any of a variety of characteristics. A friend interface may, for example, correspond to social friends, friends (or associates) associated with particular goods and/or services (also referred to herein as product interest groups), etc. For example, a friend interface may comprise an interface 170 by which the user may communicate with social friends, a friend interface may comprise an interface by which the user may communicate with buyer friends with which the user is or has been involved with product purchases (e.g., buyer group purchases), a friend interface may comprise an interface by which the user may communicate with product interest groups of which the user is a member, etc.

As a further example, a particular type of interface may comprise features linking different types of interfaces. For example, a social network interface 170 may comprise one or more interface features (e.g., messaging features) providing for communication of buyer group information to social friends via a social network. Also for example, a buyer group interface may comprise interface features by which information of the buyer group may be communicated to social friends via a social network.

As mentioned above, a friend interface may correspond to product interest groups (e.g., groups of users interested in particular products, types of products, etc.). The consumer interface 100 provides an example of such an interface at items 160, 163, 165 and 167. Generally analogous to the features of the buyer group interface aspects discussed above at items 110, 120, 130 and 140, the interface may comprise a listing of current product interest groups for the user at item 160 (which may, for example, include hyperlinks to their respective interfaces), a product interest group search feature 163, a GUI button to initiate the formation of a new product interest group 165, and a message window 167 for communicating messages associated with the product interest groups of which the user is a member.

More specifically, item 160 comprises an exemplary product interest group list 160. Such a list 160 may share any or all characteristics with the buyer group list 110 discussed previously (albeit with regard to product interest groups rather than buyer groups). Also for example, item 163 comprises an exemplary product interest group searching interface 163. Such a searching interface 163 may share any or all characteristics with the buyer group searching interface 120 discussed previously (albeit with regard to product interest groups rather than buyer groups). Additionally for example, item 165 comprises an exemplary user-selectable graphical button 165 (or other feature, for example, a hyperlink) on a GUI that, when selected, will initiate a product interest group definition interface. Such button 165 and/or product interest group interface may share any or all characteristics with the button 130 and associated buyer group definition interface 200 discussed previously (albeit with regard to product interest groups rather than buyer groups). Further for example, item 167 comprises an exemplary product interest group message interface 167. Such interface 167 may share any or all characteristics with the buyer group message interface 140 discussed previously (albeit with regard to product interest groups rather than buyer groups).

For example, an interface may comprise a user interface by which a user may specify consumer associates (e.g., other users with which the user is interested in maintaining a communicative relationship generally based on the purchase of goods and services (e.g., via buyer's groups). Such a group will also be referred to herein as a product interest group. For example, a user may desire to maintain a communicative relationship with other people of similar purchasing interests (e.g., an associative relationship based on consumer activity rather than on social factors). In such a scenario, a user may expect to receive posts from such associates regarding consumer products, product suppliers, etc., rather than receiving social information. Such consumer associates may also be organized into consumer categories (or product interest groups), for example, categories associated with respective types of consumer goods (e.g., wine associates, consumer electronics associates, soft drink associates, restaurant associates, etc.).

In an exemplary scenario involving a plurality of consumer categories, a user may select a user interface (U/I) feature (such as a graphical button, hyperlink, etc.) to specify the particular category of consumer associates with which the user desires to communicate. For example, a user desiring to communicate with the user's wine-purchasing associates may select a “wine” GUI feature to be presented with correspondence associated with the wine-purchasing associates and to generate correspondence associated with the wine-purchasing associates.

A product interest group interface may also comprise a group management interface with which the user may manage membership in product interest groups. Such a group management interface may, for example, comprise a search tool with which a user may search for product interest groups of interest to the user. Such a group management interface may also, for example, comprise user interface features by which a user may manage the user's participation in such product interest groups (e.g., requesting group admission or removal, forming new groups, communication within the group, etc.).

As mentioned above, a friend interface may correspond to social groups (e.g., groups of users interested in social networking). Such a social friend interface may, for example, be provided to the user on the same interface page as the consumer associates discussed above (e.g., in different respective page or screen portions or windows) or on a different interface page or screen. Such a social friend interface is illustrated as item 170 of FIG. 1. For example, an interface may be provided to the user on which the user may receive postings and/or messages from both consumer associates and social friends (e.g., intermixed in a single message stream, in separate respective screen areas, on separate pages, etc.).

A product interest group interface, as discussed above, may also comprise a social friend management interface with which the user may manage membership in the user's group of friends. Such a friend management interface may, for example, comprise a search tool with which a user may search for friends of interest to the user. Such a friend management interface may also, for example, comprise user interface features by which a user may manage the user's social friend interaction (e.g., requesting friend admission or removal, communication with social friends, etc.).

As mentioned above, the system may present one or more friend (or associate) management interfaces to a user. Such a user interface may, for example, be utilized by the user to manage interactions with consumer associates (or friends) and social friends. Such an interface may, for example, provide for user specification of the type of friend (or associate) with which the user desires to communicate. For example, a user may specify “social friend” to communicate with social friends. Also for example, a user may specify “electronics friends” to communicate with friends (or associates) with a common interest in the purchase of consumer electronics. Additionally, for example, a user may specify “exotic wine friends” to communicate with the user's friends (or associates) with a common interest in the purchase of exotic wines. Communicating with such friends may, for example, result in the formation of an ad hoc buyer group for the purchase of a truckload of Napa Valley wine for shipment to three designated locations in the Chicago area.

Such an interface may, for example, provide a search tool with which the user may search for social friends. Such an interface may, for example, share various characteristics with present social friend search tools. Such an interface may also, for example, comprise providing information regarding the membership of social friends in present ad hoc buyer groups formed for the purchase of a particular good and/or groups generally associated with the purchase of such consumer good.

Such an interface may, for example, provide a search tool with which the user may search for consumer friends (or associates) with which the user has common consumer goods/services interests. For example, such an interface may provide for the user to specify a particular type of consumer good and/or service in which the user is interested and specify a geographical area. In such a scenario, the user may be provided with a list of consumers in the geographical area having similar interests.

In an exemplary scenario, the user may traverse a nested consumer goods list to specify wine from a particular Napa Valley winery and specify the Chicago area. In such a scenario, the user will be presented with a list of other users in the Chicago area with an interest in purchasing wine from the particular winery. The user may then make friend (or associate) requests and the like to be included in communications regarding the specified goods and/or services, including but not limited to information regarding the formation of buyers groups.

The consumer interface 100 (e.g., a web page or application) may, for example, provide one or more interfaces with which they may present advertising information to the user. For example, item 180 at FIG. 1 shows an exemplary advertising field by which the system may present advertising information (e.g., targeted advertising information and/or general advertising information) to the user.

For example, the advertising field 180 may present targeted advertising to the user. Such targeted advertising may, for example, be based on a user's consumer transaction history. For example, the interface may present information regarding products related to products recently purchased by the user. Also for example, the interface may present information regarding consumable products purchased regularly by the user. For example, in a scenario in which the user regularly (e.g., through participation in buyer groups) purchases beer, the interface may present information regarding beer sales geographically proximate the user.

Also, such targeted advertising may, for example, be based on a user's present buyer group membership. For example, the user may be presently associated with a group purchasing televisions. In such a scenario, the interface may present information of other consumer goods related or complementary to televisions (e.g., advertisements for consoles, PVRs, game stations, recliners, satellite television providers, etc.). As another example, the user may be presently associated with a group purchasing graduation gowns. In such a scenario, the interface may present information of graduation photography services, local restaurants, graduation party goods, etc. This enables group participation in cross and up sell opportunities. In other words, the group is enabled to use the group aggregation of demand to perhaps drive lower prices for not only the desired goods, but also for complementary and higher quality goods.

Additionally, such targeted advertising may, for example, be based on product interest information specified by the user in the user's personal profile. As mentioned above, the user may input product interest information in the user's profile. Such information may be used to target advertising information to the user. Additionally, the system may track user interaction (e.g., selection of product categories, product types, purchase of products, use or selection of promotions, etc.) over time, and update the user's personal profile based on the interaction. Such information may also be used to target promotion (e.g., advertising) information to the user (e.g., after an update occurs, periodically, etc.).

Further, such targeted advertising may, for example, be based on the user's consumer friends groups (e.g., product interest groups). As mentioned above, apart from the ad-hoc buyer groups to which the user may belong for a particular purchase, the user may also belong to any number of consumer friend (or associate) groups of users that share common consumer good and/or service interests. In such an example, advertising may be targeted to the user based on the user's membership in such groups.

In addition to or instead of targeted advertising, the advertising field 180 may present general non-targeted advertising to the user.

Additionally for example, the consumer interface 100 (e.g., at the advertising field 180 or elsewhere) may present advertising by companies expressing an interest in group sales. For example, a company may advertise a product at a particular price if a particular number of consumers form a group to purchase such product. In a first exemplary scenario, a user, having been exposed to such advertising, may form a buyer group to take advantage of such offer. In a second exemplary scenario, the advertising company (or middleman) may have already formed the buyer group. In such a scenario, the user need only join the group. The advertised price may, for example, be based on group size as measured on a particular date. For example, the advertising company may specify a first price for a thousand buyers and decrease such price if an additional thousand buyers join the buyer group. Joiners of a buyer group formed to take advantage of such a supplier offer may, for example, specify a maximum price (or minimum group size) when joining such a group. For example, a user may join such a group, specifying that the user's participation is contingent upon the price ending up at or below a specified maximum price.

The consumer interface 100 (e.g., a web page or application) may present a blog (or wall) for buyer group experiences. For example, the consumer interface 100 may present a single wall for all buyer groups of which the user is a member, or a respective wall for each buyer group of which the user is a member. Also for example, a U/I may be presented to the user by which the user may specify buyer group-related blogs in which the user is presently interested. The user may also specify various aspects of such blogs as presented to the user.

The previous discussion presented various non-limiting exemplary aspects of a personal (or user) consumer interface. Such aspects are merely illustrative and are non-limiting. Accordingly, the scope of various aspects of the present invention should not be limited by any particular characteristics of such exemplary aspects unless explicitly claimed.

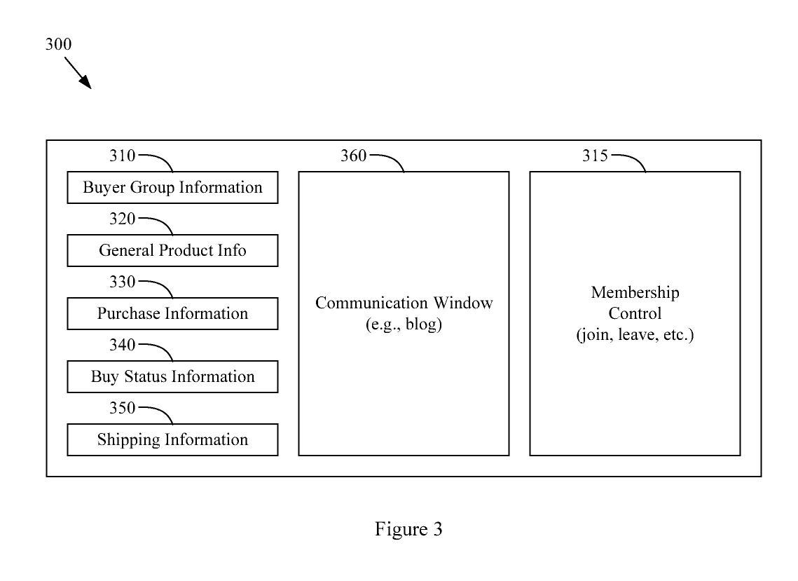

Various aspects of the present invention may also comprise providing a buyer group interface (e.g., a dedicated interface, a buyer group-related portion of another interface (e.g., of a social networking page or screen, a product interest group page or screen, etc.)). A non-limiting example of such a buyer group interface 300 is illustrated at FIG. 3.

Turning to FIG. 3, such figure shows a non-limiting example of a buyer group interface 300, in accordance with various aspects of the present invention. The exemplary buyer group interface 300 illustrated in FIG. 3 and discussed herein is presented for illustrative purposes only and is non-limiting. Accordingly, the scope of various aspects of the present invention should not be limited by any characteristics of the exemplary buyer group interface 300 unless explicitly claimed.

Note that any or all of the information and/or functionality discussed below may be placed in individual user pages or screen and/or product interest group pages or screens, and any or all of the information and/or functionality discussed with regard to such individual user pages or product interest group pages may be placed in the buyer group interface.

As discussed above, one or more consumer interface pages (e.g., web pages, application screens, or other U/I pages) may be presented to the user that are specifically related to the user and/or groups of friends (social or consumer friends) of the user. Various aspects of the present invention also comprise presenting an interface (e.g., a web page or application screen) to the user that is specifically dedicated to a particular ad-hoc buyer group (e.g., an ad-hoc buyer group formed for the purpose of a single bulk consumer product purchase).

Recall that a non-limiting exemplary interface 200 presented for the formation of a buyer group was discussed previously and is illustrated at FIG. 2. The buyer group interface 300 (e.g., a web page or application screen) may, for example, provide information similar to that previously discussed for the buyer group (e.g., in a non-editable fashion) to the buyer group members and potential members. Such a buyer group interface 300 (e.g., a web page or application screen) may, for example, comprise any or all of the features and/or information discussed above with regard to FIG. 2 and related to the proposed and/or pending group purchase.

For example and without limitation, such features and/or information may comprise buyer group information 310. Such buyer group information 310 may, for example, comprise group coordinator information (e.g., if the buyer group is established to have a coordinator or administrator). Such buyer group information 310 may also, for example, comprise buyer group membership information. Such buyer group membership information may, for example, be presented by a user-specified name. For example, if the user desires, though purchasing information may be detailed, a user may, in the public forum, decide to maintain some level of anonymity. In this manner, a user may decide to participate in the buyer group, but otherwise withhold certain personal information. The buyer group interface 300 may also, for example, comprise user interface features for joining and/or leaving the buyer group 315.

Also for example, such features and/or information may comprise general product (e.g., consumer good and/or service) information 320. Such general product information 320 may, for example, comprise information about the good and/or service being purchased by the buyer group. Such general product information 320 may also, for example, comprise product research information regarding the good and/or service being purchased (and/or links thereto), consumer reports, manufacturer information, etc. Members and potential members of a buyer group may then, for example, research the proposed product (e.g., research price information, product/company reliability information, source alternative information, etc.). The general product information 320 may also, for example, comprise product warranty information.

Additionally for example, such features and information may comprise product purchase information 330. Such product purchase information 330 may, for example, comprise the monetary terms of the proposed and/or finalized product purchase, whether the proposed purchase is a fixed-price or auction purchase (e.g., with a maximum specified price), information of the warranty specified, information of the type of shipping specified, etc.

Further for example, such features and information may comprise information regarding the status of the buy 340. Such buy status information 340 may, for example, identify whether the group is still in the building process, including for example, the number of participants, the desired number of participants, etc. Also for example, such buy status information 340 may comprise information indicating that the group has been filled to the desired level, but is still allowing additional members. Additionally for example, such buy status information 340 may comprise information indicating that the group membership has been finalized.

The buy status information 340 may also, for example, comprise information indicating that the system is currently seeking a seller willing to meet the buyer group's purchase terms (or, for example, to provide a counter-offer to the buyer group regarding price, group size, etc.). In an auction scenario, the buy status information 340 may comprise information indicating the auction status (e.g., information indicating the outstanding seller bids, the lowest bid received so far, etc.).

The buy status information 340 may additionally, for example when a sales agreement has been reached, comprise information describing the awarded sale. Such information may, for example, comprise information identifying the company awarded the sale, contact information of a seller's representative associated with the purchase, etc.

The buy status information 340 may further, for example, comprise information indicating that the agreement is in a finalization state, for example in which the buyers have the ability to provide their final approval (e.g., when presented with the final agreement terms). In an exemplary scenario in which a seller is identified and the seller agrees to the buyer group terms, the system may present the finalized terms to each user in the buyer group for the user's ultimate approval. In such a scenario, if a particular number of buyers decline the deal, the number of buyers may be presented back to the seller to determine whether the seller desires to proceed with the reduced number of buyers.

The buy status information 340 may also, for example, comprise information indicating that the seller is preparing shipment. For example, such shipment information may comprise information of an anticipated shipping date, information indicating that the purchased product has been shipped, information indicating that the product has been delivered, etc.

Further for example, such features and information may comprise shipping information 350. Such shipping information 350 may, for example, comprise shipment tracking information. Such shipping information 350 may, for example in a scenario in which products are shipped individually, comprise respective shipment tracking information for each user in accordance with the desired shipment method. Also for example, in a scenario in which the product is shipped in bulk, the shipping tracking information 350 may comprise information in accordance with such bulk shipment method (e.g., truck location, etc.).

The buyer group interface 300 may also, for example, comprise a blog (or wall or message board) 360 for the particular buyer group. For example, users in the buyer group (or considering membership in the buyer group) may utilize the blog 360 to discuss the product, pricing, purchase status, delivery status, product quality, etc. Also for example, users may utilize the blog 360 to discuss their after-purchase experiences. For example, users may utilize the blog 360 to discuss the quality of the delivered product, customer support after the sale, product care, potential purchase of additional products, product reviews, seller ratings, etc.

The buyer group interface 300 may comprise a seller interface (e.g., a message window, a link to a seller page or screen, etc.). A seller (or potential seller) may utilize the seller interface to interact with the group. For example, a seller may use such an interface to accept the proposed purchase terms, or to announce such acceptance. A seller may also, for example, use such a page to request and/or maintain a dialog with the group, group administrator/moderator, etc. (e.g., for negotiating with regard to any or all transaction details discussed herein, providing a counter-offer, providing a particular price or other incentive only if a particular minimum group size is reached, providing a particular price only if a group size specified for the group is increased to a particular amount, providing a future discount (e.g., on related or complementary products) if a deal is reached with the buyer group or reached within a particular time, including additional products at no or little charge if the size of the buyer group reaches a particular threshold, offering a relatively higher quality product instead of the specified product at little or no additional cost, etc.).

A seller may, for example, be granted access to such functionality after an agreement has been reached and/or during deal negotiations. As mentioned below, the system may provide a dedicated seller interface (e.g., with access restricted to only the seller or access also allowed to the group).

The buyer group interface 300 might, for example, exist only for the duration of an associated consumer transaction (or for a particular amount of time following completion of the consumer transaction). Alternatively, for example, such an interface 300 (e.g., a web page) may be archived for later recall and analysis.

As discussed above, various aspects of the present invention may comprise providing an interface to potential sellers. Such a seller interface may comprise any of a variety of characteristics, non-limiting examples of which will now be provided. Such a seller interface may, for example, comprise a dedicated web page or application, a buyer group-related portion of another interface (e.g., of a social networking page, a product interest group page), etc. The discussion above mentioned various types of information and functionality that may be presented to the members or potential members of a buyer group. Any or all of such information and functionality may also analogously be provided to a seller (e.g., before reaching agreement, after reaching agreement, etc.), non-limiting examples of which will now be provided.

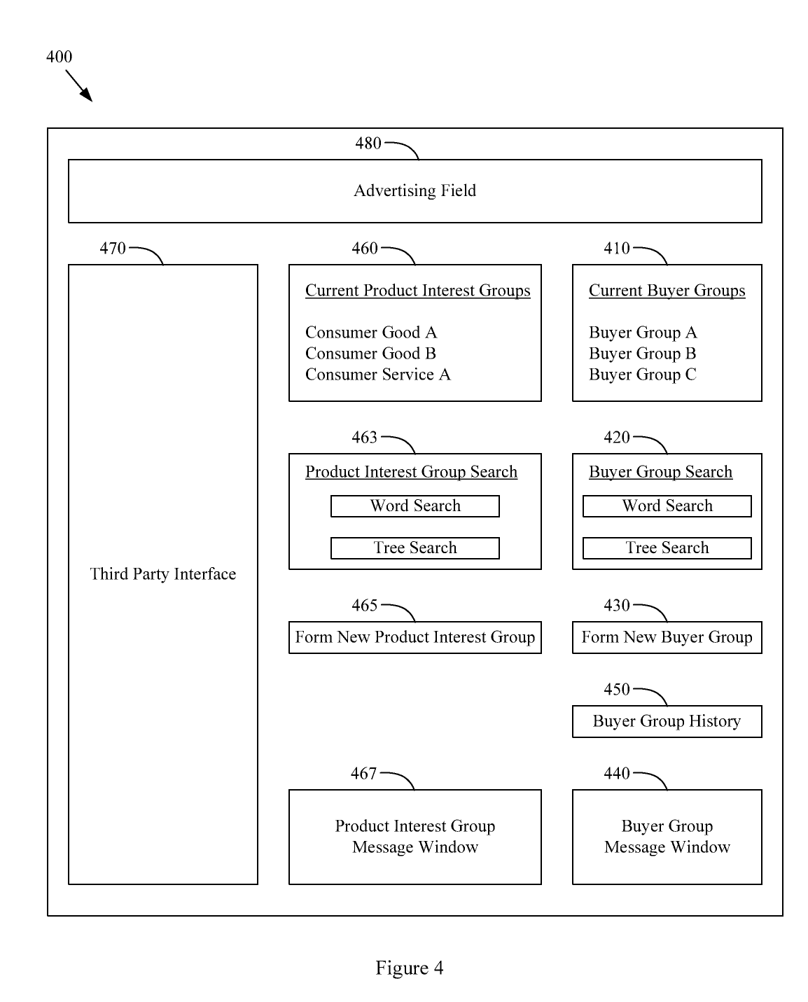

Turning next to FIG. 4, such figure shows a non-limiting example of a seller interface 400, in accordance with various aspects of the present invention. The exemplary seller interface 400 illustrated in FIG. 4 and discussed herein is presented for illustrative purposes only and is non-limiting. Accordingly, the scope of various aspects of the present invention should not be limited by any characteristics of the exemplary seller interface 400 unless explicitly claimed. The seller interface 400 may, for example, share any or all characteristics with the consumer interface 100 illustrated at FIG. 1 and discussed previously, albeit adapted for general communication with a seller rather than a buyer.

The seller interface 400 (e.g., a web page or application) may provide a list of buyer groups in which the seller is presently interested (e.g., in which the seller has flagged for tracking, in which the seller is in present negotiations, in which the seller is completing a purchase transaction, etc.). For example, an exemplary list is illustrated at item 410. Such an exemplary buyer group list 410 may, for example, comprise links (e.g., hyperlinks) to respective web pages comprising information associated with each buyer group. For example, a later discussion will present various aspects of such a buyer group interface (or buyer group page) adapted for presentation to a seller. Seller-selection of a buyer group in the buyer group list 410 presented to the seller may, for example, result in a seller interface for the selected buyer group being presented to the user.

The exemplary buyer group list 410 may, for example, provide the ability for the seller to modify group interest (e.g., stop tracking the selected buyer group, enter into active negotiations with the selected buyer group, passively monitor formation of the selected buyer group, monitor other seller interaction with the selected buyer group, etc.). As a non-limiting example, a seller may (e.g., with a mouse or touch pad) select a listed buyer group, and in response to such a selection, the system may present the user with options to stop tracking the selected buyer group, enter into negotiations with the selected buyer group, monitor formation (or growth) of the selected buyer group, removal of the selected buyer group from the list 410, etc.

In the buyer group list 410, each buyer group may have one or more visual indications (e.g., textual indication, graphical feature (such as an icon or “fuel gauge”), color, etc.) associated therewith to indicate general transaction status. For example, each buyer group may be listed with quick-glance transaction status summary information showing high-level status of the buyer group and/or the consumer product transaction associated therewith (e.g., presently building the group, presently seeking seller (or supplier), seller located and waiting for final buyer commitment and/or fund transfer, supplier preparing shipment, in negotiations with a seller, products shipped and in-route, products delivered, etc.). Also for example, each buyer group may be listed with quick-glance indications of the seller's specified interest in such buyer group (e.g., indicating whether the seller is presently in negotiations with the selected buyer group, indicating that the seller is merely monitoring progress of the selected buyer group, indicating that the seller has reached agreement with the selected buyer group, indicating that the seller is presently performing a product transaction with the selected buyer group, etc.) Note that the system may also communicate a notification message to the seller when a buyer group status changes (e.g., notifying the seller upon completion of buyer group formation, upon buyer group membership reaching a particular level, upon communication being established between a buyer group of interest and another seller, upon establishment of mutually agreeable terms (or closing a deal) with a buyer group, upon shipment of a product, upon a counteroffer being received from a buyer group, etc.).

A seller interface 400 (e.g., a web page or application) may, for example, provide a searching interface with which the seller may find presently existing buyer groups (e.g., buyer groups of which the seller is not presently tracking, for example as might appear in the buyer group list 410, but might have a business interest). For example, an exemplary buyer group searching interface is illustrated at item 420 of FIG. 4. A system implementing various aspects of the present invention may, for example, comprise a database of buyer groups that have been formed. Such a database may, for example, be centralized or distributed between a plurality of sites (e.g., regional sites).

An exemplary buyer group searching interface 420 may, for example, a search field for entering search criteria that provides the seller the capability to search for a buyer group based on any of a variety of buyer group search criteria. For example, the buyer group searching interface 420 may provide the ability for the seller to search for a buyer group based on any one or more of: a specific product, a product type, a product category, a geographical area, a buyer group identity, a buyer group purchase status, etc. The buyer group searching interface 420 may, for example, provide for seller-specification of logical search combinations by which the seller may specify any one or more of a plurality of search criteria.

Also for example, the buyer group searching interface 420 may provide for buyer group searching based on a nested (or tree) structure. For example, in a non-limiting exemplary scenario, a seller may select a geographical region (e.g., county, city, metropolitan area, state, etc.) from a list of geographical regions presented to the seller by the buyer group searching interface 420 and be presented with buyer groups (and, for example, links to respective interfaces (e.g., web pages or applications) associated with such buyer groups) associated with the selected geographical region. In another exemplary scenario, a seller may select a product type (e.g., television, wine, computer, telephone, soda, etc.) from a list of product types presented to the user by the buyer group searching interface 420 and be presented with buyer groups (and, for example, links to respective interfaces (e.g., web pages or applications) associated with such buyer groups) associated with the specified product type. For example, a seller of televisions may specify “television” (or a specific type of television of which the seller has an inventory) and be presented with a list of buyer groups (or links associated therewith) that have been formed for the purchase of televisions (or the specific type of television).

Additionally for example, the buyer group searching interface 420 may comprise an interface by which the seller may input filtering information. For example, using such an interface, a seller may specify an interest only in buyer groups in the Chicago metropolitan area. Also for example, a seller may specify an interest only in buyer groups looking for to-the-door delivery of an ordered item as opposed to a drop shipment to a central location. Additionally for example, a seller may specify an interest only in buyer groups that specify that a particular amount of down payment will be made (as opposed to billing only after delivery, etc.). Further for example, a seller may specify an interest only in buyer groups of at least a minimum size.

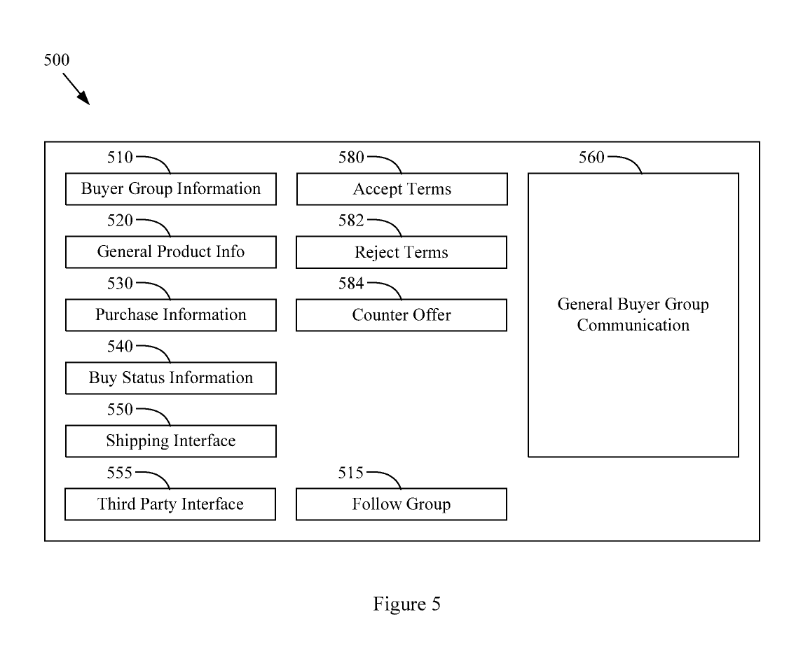

As mentioned above, the seller interface 400 may provide for selection of a buyer group to cause presentation of an interface to the seller that is specifically related to the selected buyer group. Such an interface may also be unique to that particular seller. Such an interface may, for example, provide more detailed information about the selected buyer group that the information presented on the seller interface. A non-limiting exemplary interface of such type is shown in FIG. 5.

Turning next to FIG. 5, such figure shows a non-limiting example of a buyer group interface portion of a seller interface 500, in accordance with various aspects of the present invention. The exemplary buyer group interface 500 illustrated in FIG. 5 and discussed herein is presented for illustrative purposes only and is non-limiting. Accordingly, the scope of various aspects of the present invention should not be limited by any characteristics of the exemplary buyer group interface 500 unless explicitly claimed.

Note that any or all of the information and/or functionality discussed below may be placed in individual seller pages and/or product interest group pages, and any or all of the information and/or functionality discussed with regard to such seller pages or product interest group pages may be placed in the buyer group interface.

As discussed above, one or more seller interface pages (or web pages, or other U/I pages) may be presented to the seller that are specifically related to a selected buyer group. Various aspects of the present invention also comprise presenting an interface (e.g., a web page or application) to the seller that is specifically dedicated to a particular ad-hoc buyer group (e.g., an ad-hoc buyer group formed for the purpose of a single bulk consumer product purchase).

Recall that a non-limiting exemplary interface 200 presented for the formation of a buyer group was discussed previously and is illustrated at FIG. 2. The buyer group interface 500 (e.g., a web page or application) may, for example, provide information similar to that previously discussed for the buyer group (e.g., in a non-editable fashion) to the seller. Such a buyer group interface 500 (e.g., a web page or application) may, for example, comprise any or all of the features and/or information discussed above with regard to FIG. 2 and related to a proposed and/or pending buyer group purchase.

For example and without limitation, such features and/or information may comprise buyer group information 510. Such buyer group information 510 may, for example, comprise group coordinator information (e.g., if the buyer group is established to have a coordinator or administrator). Such buyer group information 510 may also, for example, comprise buyer group membership information. Such buyer group membership information may, for example, be presented by a user-specified name. For example, if the user desires, though purchasing information may be detailed, a user may, in the public forum, decide to maintain some level of anonymity. In this manner, a user may decide to participate in the buyer group, but otherwise withhold certain personal information. The buyer group interface 500 may also, for example, comprise seller interface features 515 for indicating whether the seller desires to monitor the buyer group, receive status messages for the buyer group, discontinue monitoring the buyer group, etc.

Also for example, such features and/or information may comprise general product (e.g., consumer good and/or service) information 520. Such general product information 520 may, for example, comprise information about the good and/or service being purchased by the buyer group. Such general product information 520 may also, for example, comprise product research information regarding the good and/or service being purchased (and/or links thereto), consumer reports, manufacturer information, etc. The seller (or user) may then, for example research the proposed product (e.g., research price information, product/company reliability information, source alternative information, research seller competition, product reviews, seller ratings, etc.). The general product information 520 may also, for example, comprise product warranty information (e.g., manufacturer warranty information, supplier warranty information, etc.).

Additionally for example, such features and information may comprise product purchase information 530. Such product purchase information 530 may, for example, comprise the monetary terms of the proposed and/or finalized product purchase, whether the proposed purchase is a fixed-price or auction purchase (e.g., with a maximum specified price), information of the warrantee specified, information of the type of shipping specified, etc.

Further for example, such features and information may comprise information regarding the status of the buy 540. Such buy status information 540 may, for example, identify whether the buyer group is still in the building process, including for example, the number of participants, the desired number of participants, etc. Also for example, such buy status information 540 may comprise information indicating that the buyer group has been filled to the desired level, but is still allowing additional members. Additionally for example, such buy status information 540 may comprise information indicating that the group membership has been finalized.

The buy status information 540 may also, for example, comprise information indicating that the system is currently seeking a seller willing to meet the buyer group's purchase terms (or, for example, to provide a counter-offer to the buyer group regarding price, group size, etc.). In an auction scenario, the buy status information 540 may comprise information indicating the auction status (e.g., information indicating the outstanding seller bids, the lowest bid received so far, etc.).

The buy status information 540 may additionally, for example when a sales agreement has been reached, comprise information describing the awarded sale. Such information may, for example, comprise information identifying the company awarded the sale, contact information of a seller's representative associated with the purchase, etc.

The buy status information 540 may further, for example, comprise information indicating that the agreement is in a finalization state, for example in which the buyer group members and/or seller have the ability to provide their final approval (e.g., when presented with the final agreement terms). In an exemplary scenario in which a seller is identified and the seller agrees to the buyer group terms, the system may present the finalized terms to the seller for the seller's ultimate approval. In such a scenario, if a particular number of buyers decline the deal, the number of buyers may be presented back to the seller to determine whether the seller desires to proceed with the reduced number of buyers.

The buy status information 540 may also, for example, comprise information indicating that the seller is preparing shipment. For example, such shipment information may comprise information of an anticipated shipping date, information indicating that the purchased product has been shipped, information indicating that the product has been delivered, etc.

Further for example, such features and information may comprise shipping information 550. Such shipping information 550 may, for example, comprise shipment tracking information. Such shipping information 550 may, for example in a scenario in which products are shipped individually, comprise respective shipment tracking information for each user in accordance with the desired shipment method. Also for example, in a scenario in which the product is shipped in bulk, the shipping information 550 may comprise information in accordance with such bulk shipment method (e.g., truck location, etc.).

A shipping information 550 interface may, for example, include an interface by which the seller may input shipping information associated with the deal (e.g., estimated shipping date, shipping date information, shipment tracking information, courier information, etc.). Such information may then, for example, be communicated to a buyer group and/or third parties associated with the transaction.

The buyer group interface 500 provided to the seller may additionally, for example, comprise a third party interface 555 by which the seller may communicate with third parties (e.g., product sources to the seller, selling partners, shipping companies, financial transaction companies, transaction broker companies, insurance companies, etc.) related to the buyer group. For example, in an exemplary scenario in which a seller is assembling a team of commercial entities to provide the product to the buyer group (e.g., an ad hoc seller group for the transaction specified by the buyer group), the seller may utilize the third party interface 555 to communicate with other members of the team.

Further for example, such a third party interface 555 may comprise an interface by which a seller may be notified of willing third party participants for transactions with buyer groups. For example, such a third party 555 interface may comprise a list (e.g., a pull-down menu list) of shipping companies that have expressed an interest in participating in buyer group transactions in general and/or in the particular transaction specified by the buyer group. Such a list may, for example, include information of shipping terms (negotiable or not). Also for example, such a third party interface 555 may comprise information of third party financial enterprises that are interested in providing financial services (e.g., escrow services, credit, etc.) for buyer group transactions in general and/or the particular transaction specified by the buyer group.

Note that any or all of the third party interface functionality discussed with regard to item 555 may similarly be provided by the seller interface 400 (e.g., at item 470).

Also for example, as discussed elsewhere herein, an enterprise that implements various aspects of the present invention (e.g., buyer group formation, seller interaction, deal brokering, transaction monitoring, etc.) may receive compensation for such implementation. The details of such compensation may be presented to the seller, for example explicitly and/or rolled into the buyer group demand, by a third party interface (e.g., item 555, item 470, etc.). For example, a price set by a buyer group may be padded when presented to a seller to include commission for the system operator. Also for example, information of the implementer's exact commission may be provided to the seller (e.g., in a fixed number or percentage form, or a negotiable form), for example in the buyer group interface 500. For example, in an exemplary scenario in which the system implementer's commission is negotiable, the system may provide an interface (e.g., third party interface 555 and/or third party interface 470) by which the seller may propose a counter-offer to the implementer's commission.

The buyer group interface 500 provided to the seller may also, for example, comprise a blog (or wall or message board) 560 for the particular buyer group. For example, users in the buyer group (or considering membership in the buyer group) may utilize the blog 560 to discuss the product, pricing, purchase status, delivery status, product quality, etc. Also for example, users may utilize the blog 560 to discuss their after-purchase experiences. For example, users may utilize the blog 560 to discuss the quality of the delivered product, customer support after the sale, product care, potential purchase of additional products, product reviews, seller ratings, etc. The seller may or may not have access to input capability for such blog 560 (e.g., the seller might only be provided read-only access to such blog). Alternatively, the interface 500 may provide the seller the capability to post message on the blog 560.

The buyer group interface 500 may comprise a dedicated seller interface (e.g., a message window, a link to a seller page or screen, etc.). A seller (or potential seller) may utilize the seller interface to interact with the buyer group. For example, a seller may use such a page to accept the proposed purchase terms, or to announce such acceptance. A seller may also, for example, use such a page to request and/or maintain a dialog with the group, group administrator/moderator, etc. (e.g., for negotiating with regard to any or all transaction details discussed herein, providing a counter-offer, providing a particular price or other incentive only if a particular minimum group size is reached, providing a particular price only if a group size specified for the group is increased to a particular amount, providing a future discount (e.g., on related or complementary products) if a deal is reached with the buyer group or reached within a particular time, including additional products at no or little charge if the size of the buyer group reaches a particular threshold, offering a relatively higher quality product instead of the specified product at little or no additional cost, etc.).

A seller may, for example, be granted access to such functionality after an agreement has been reached and/or during deal negotiations. As mentioned below, the system may provide a dedicated seller interface (e.g., with access restricted to only the seller or access also allowed to the group).

Such a seller interface may, for example, include a dialog box where the seller may post general comments regarding the deal. Additionally, such a dialog box may be a two-way dialog box by which the buyer group administrator and/or individual members may post comments. Various types of information received from the seller (e.g., counter-offer information, order status information, shipping information, etc.) may be linked to (e.g., posted on) the buyer group page, so members of the buyer group may access such information. Similarly, various types of information received from the buyer group (e.g., offer information, group size information, etc.) may be linked to (e.g., posted on) the seller interface, so the seller may access such information.

For example, the interface 500 may comprise an acceptance interface 580 by which a seller may specify that the seller agrees to the buyer group's purchase terms and desires to form a supply contract with the buyer group. For example, such an acceptance interface 580 may provide a user interface feature by which the system may interact with a seller (or potential seller) to close the deal (e.g., including the input of seller acceptance information, digital signatures, enterprise information, etc.). Such a seller interface may, for example, comprise an interface by which the seller may separately acknowledge acceptance of each of a plurality of buyer group terms (e.g., price, shipping, warrantee, etc.).

Also for example, the interface 500 may comprise a rejection interface 582 by which the seller may specify that the seller rejects the buyer's proposed purchase terms.

Additionally for example, the interface 500 may comprise a counter offer interface 584 by which the seller may indicate a desire to make a counter offer and/or an original offer to the buyer group's terms. Such a counter offer interface 584 may, for example, include a list of the buyer group's proposed purchase terms with an adjacent interface field allowing the seller to accept and/or counter each particular term, or in various scenarios provide an original offer for a particular open term. For example, the counter offer interface 584 may provide to the seller the buyer group terms in a selectable form. In such an implementation, a seller may select a particular term (e.g., price) and/or a particular buyer group characteristic (e.g., group size) and be presented with a user interface feature by which the seller may propose a change to such selected buyer group term and/or characteristic and communicate such a change to the buyer group. Upon completing utilization of the counter offer interface 584, the interface 584 may provide for the seller to indicate that the specified counter offer (or original offer) be communicated to the buyer group (e.g., on a buyer group interface page 300 as discussed previously with regard to FIG. 3). In another exemplary scenario, a buyer group might have been formed with various product purchase terms undefined (e.g., exact product identification, price, shipping, warrantee, timeframe, etc.). In such an exemplary scenario, the counter offer interface 584 provides for the seller to input original offer terms (e.g., as opposed to counter-offer terms), which may then be provided to the buyer group. For example, the seller may utilize the interface 584 to provide original proposals for such terms (e.g., seller-provided proposed price, exact product identity, shipping terms, warranty provisions, transaction times, etc.).

The buyer group interface 500 might, for example, exist only for the duration of an associated consumer transaction (or for a particular amount of time following completion of the consumer transaction). Alternatively, for example, such an interface 500 (e.g., a web page or application) may be archived for later recall and analysis.

Returning now to the discussion of FIG. 4, the seller interface 400 (e.g., a web page) may, for example, provide a buyer group definition interface with which the seller may define (or form) a new buyer group (or a link to such an interface). For example, item 430 at FIG. 4 shows a seller-selectable graphical button 430 (or other feature, for example, a hyperlink) on a GUI that, when selected, will initiate a buyer group definition interface. Such an interface may be presented to the seller on a seller interface (e.g., an interface page) that is dedicated exclusively or in-part to the definition of a buyer group. An exemplary buyer group definition interface 200, for example for utilization by a buyer and/or third party for formation of a buyer group, was presented in FIG. 2 and discussed previously. A buyer group definition interface presented to a seller may share any or all characteristics with such previously discussed interface 200.

The seller interface 400 (e.g., a web page or application) may, for example, provide a buyer group message interface with which the seller may communicate (e.g., receive and/or transmit) messages concerning buyer groups (e.g., concerning buyer groups of which the seller has an interest, of which the seller is in negotiations with, etc.). For example, item 440 at FIG. 4 shows a buyer group message interface (e.g., a message window) by which information of existing buyer groups may be presented to the user in an unsolicited manner. Such a buyer group message interface 440 may comprise any of a variety of characteristics (e.g., characteristics of a repeating scrolling list, scrolling banner, ticker, etc.).

For example, a system implementing various aspects of the present invention may analyze a seller profile (either explicitly formed by the seller and/or formed based on seller sale activity) to identify present buyer groups in which the seller might be interested. The buyer group message interface 440 may present information of such identified buyer groups to the seller (e.g., in a solicited and/or unsolicited manner). In an exemplary scenario, the buyer group message interface 440 may present a scrolling list or banner of potential buyer groups of interest, which may then be selected by the seller to cause the system to present more detailed information of a selected buyer group to the seller (e.g., on an interface like the buyer group interface 500 discussed previously).

The seller interface 400 (e.g., a web page or application) may, for example, provide a buyer group history interface with which the seller may store, retrieve, and/or review information regarding prior commercial transactions. For example, item 450 at FIG. 4 shows a buyer group history interface by which information of prior buyer group commercial transactions may be presented to the seller and/or received from the seller. Such a buyer group history interface 450 may comprise any of a variety of characteristics.

For example, the buyer group history interface 450 may comprise a seller interface by which the seller can enter information associated with a buyer group purchase (e.g., lessons learned, buyers and/or buyer groups to avoid, third parties to avoid, shipping experiences, experiences with partners and/or other third party participants in transactions, warrantee experiences, product quality information, etc.). Also for example, the buyer group history interface 450 may comprise an interface whereby a seller can retrieve and review the details of previous sales, including product details, financial details, buyer group details, and can further review comments offered by other transaction participants.

The seller interface 400 (e.g., a web page or application) may, for example, provide one or more third party interfaces with which the seller may perform networking. For example, item 470 at FIG. 4 shows an exemplary social friend interface 470 by which the seller may communicate with designated third parties (e.g., selling partners, shipping parties, financial parties, product sources, etc.). The third party interface 470 may comprise any of a variety of characteristics. The third party interface 470 may, for example, correspond to third parties associated with particular goods and/or services (e.g., of which the seller has an interest).

The seller interface 400 may provide an interface with product interest groups (e.g., groups of buyers and/or sellers interested in particular products, types of products, product categories, etc.). The seller interface 400 provides an example of such an interface at items 460, 463, 465 and 467. Generally analogous to the features of the buyer group interface aspects discussed above at items 410, 420, 430 and 440, the interface may comprise a listing of current product interest groups for the seller at item 460 (which may, for example, include hyperlinks to their respective interfaces), a product interest group search feature 463, a GUI button to initiate the formation of a new product interest group 465, and a message window 467 for communicating messages associated with the product interest groups of which the user is a member.

More specifically, item 460 comprises an exemplary product interest group list 460. Such a list 460 may share any or all characteristics with the buyer group list 410 discussed previously (albeit with regard to product interest groups rather than buyer groups). Also for example, item 463 comprises an exemplary product interest group searching interface 463. Such a searching interface 463 may share any or all characteristics with the buyer group searching interface 420 discussed previously (albeit with regard to product interest groups rather than buyer groups). Additionally for example, item 465 comprises an exemplary user-selectable graphical button 465 (or other feature, for example, a hyperlink) on a GUI that, when selected, will initiate a product interest group definition interface. Such button 465 and/or product interest group interface may share any or all characteristics with the button 430 and associated buyer group definition interface 200 discussed previously (albeit with regard to product interest groups rather than buyer groups). Further for example, item 467 comprises an exemplary product interest group message interface 467. Such interface 467 may share any or all characteristics with the buyer group message interface 440 discussed previously (albeit with regard to product interest groups rather than buyer groups).

For example, an interface may comprise a seller interface by which a seller may specify consumer, seller, and/or third party associates (e.g., other parties with which the seller is interested in maintaining a communicative relationship generally based on the purchase of goods and services (e.g., via buyer's groups). Such a group will also be referred to herein as a product interest group. For example, a seller may desire to maintain a communicative relationship with other parties of similar product interests (e.g., an associative relationship based on consumer and/or supplier activity rather than on social factors). In such a scenario, a seller may expect to receive posts from such associates regarding consumer products, product suppliers, etc., rather than receiving social information. Such associates may also be organized into categories (or product interest groups), for example, categories associated with respective types of consumer products (e.g., wine associates, consumer electronics associates, soft drink associates, restaurant associates, etc.).

In an exemplary scenario involving a plurality of consumer categories, a seller may select a seller interface (U/I) feature (such as a graphical button, hyperlink, etc.) to specify the particular category of associates with which the seller desires to communicate. For example, a seller desiring to communicate with the seller's wine-providing and/or wine-purchasing associates may select a “wine” GUI feature to be presented with correspondence associated with such associates and to generate correspondence associated with such associates.

A product interest group interface may also comprise a group management interface with which the seller may manage membership in product interest groups. Such a group management interface may, for example, comprise a search tool with which a seller may search for product interest groups of interest to the seller. Such a group management interface may also, for example, comprise seller interface features by which a seller may manage the seller's participation in such product interest groups (e.g., requesting group admission or removal, forming new groups, communication within the group, etc.).

As mentioned above, the seller interface 400 may also comprise a social interface that may correspond to social groups (e.g., groups of users interested in social networking). Such a social friend interface may, for example, be provided to the seller on the same interface page as the associates discussed above (e.g., in different respective page portions or windows) or on a different interface page. Such a social friend interface is not illustrated in FIG. 4, but may be presented in its own window and/or upon selection of an interface feature causing such interface to be presented to the seller. For example, an interface may be provided to the seller on which the seller may receive postings and/or messages from both commercial associates and social friends (e.g., intermixed in a single message stream, in separate respective screen areas, on separate pages, etc.).

A product interest group interface, as discussed above, may also comprise a social friend management interface with which the seller may manage membership in the seller's group of friends. Such a friend management interface may, for example, comprise a search tool with which a seller may search for friends of interest to the seller. Such a friend management interface may also, for example, comprise seller interface features by which a seller may manage the seller's social friend interaction (e.g., requesting friend admission or removal, communication with social friends, etc.).

As mentioned above, the system may present one or more friend (or associate) management interfaces to a seller. Such a seller interface may, for example, be utilized by the seller to manage interactions with commercial associates (or friends) and social friends. Such an interface may, for example, provide for seller specification of the type of friend (or associate) with which the seller desires to communicate. For example, a seller may specify “social friend” to communicate with social friends. Also for example, a seller may specify “electronics friends” to communicate with friends (or associates) with a common interest in the purchasing, supplying, and/or shipping of consumer electronics. Additionally, for example, a seller may specify “exotic wine friends” to communicate with the seller's friends (or associates) with a common interest in selling, locating, shipping, and/or supplying exotic wines. Communicating with such friends may, for example, result in the formation of an ad hoc transaction group for the acquisition of a truckload of Napa Valley wine for shipment to a buyer group in the Chicago area.

Such an interface may, for example, provide a search tool with which the seller may search for social friends. Such an interface may, for example, share various characteristics with present social friend search tools. Such an interface may also, for example, comprise providing information regarding the membership of social friends in present ad hoc buyer groups or supplier groups formed for the purchase and/or provision of a particular good.

Such an interface may, for example, provide a search tool with which the seller may search for commercial friends (or associates) with which the seller has common consumer goods/services interests. For example, such an interface may provide for the seller to specify a particular type of consumer good and/or service in which the seller is interested in providing and specify a geographical area. In such a scenario, the seller may be provided with a list of consumers and/or buyer groups in the geographical area having similar interests, and/or a list of other commercial enterprises that may be interested in working with the seller to supply products corresponding to such interests.

In an exemplary scenario, the seller may traverse a nested consumer goods list to specify wine from a particular Napa Valley winery and specify the Chicago area. In such a scenario, the seller will be presented with a list of other entities in the Chicago area with an interest in purchasing and/or supplying wine from the particular winery. The seller may then make friend (or associate) requests and the like to be included in communications regarding the specified goods and/or services, including but not limited to information regarding the formation of partnerships for a commercial transaction and/or buyer group desiring to purchase such specified goods and/or services.

The consumer interface 400 (e.g., a web page or application) may, for example, provide one or more interfaces with which they may present advertising information to the seller. For example, item 480 at FIG. 4 shows an exemplary advertising field by which the system may present advertising information (e.g., targeted advertising information and/or general advertising information) to the seller.

For example, the advertising field 480 may present targeted advertising to the seller. Such targeted advertising may, for example, be based on a seller's consumer transaction history. For example, the interface may present information regarding products related to products recently sold by the seller. Also for example, the interface may present information regarding consumable products supplied regularly by the seller. For example, in a scenario in which the seller regularly (e.g., through performing commercial transactions with buyer groups) provides beer, the interface may present information regarding wholesale beer sales geographically proximate the user.

Also, such targeted advertising may, for example, be based on a seller's present buyer group interests. For example, the seller may have expressed an interest in buyer groups purchasing televisions. In such a scenario, the interface may present information of commercial enterprises associated with other consumer goods related to televisions (e.g., advertisements for consoles, PVRs, game stations, recliners, satellite television providers, etc.). As another example, the seller may be presently associated with a group purchasing graduation gowns. In such a scenario, the interface may present information of graduation photography services, local restaurants, graduation party goods, etc.

Additionally, such targeted advertising may, for example, be based on product interest information specified by the seller in the seller's profile. The seller may input product interest information in the seller's profile, for example when registering with a system performing various aspects of the present invention and/or upon maintaining such registration. Such information may be used to target advertising information to the seller. Additionally, the system may track seller interaction over time, and update the seller's profile based on the interaction. Such information may also be used to target promotion (e.g., advertising) information to the seller (e.g., after an update occurs, periodically, etc.).

Further, such targeted advertising may, for example, be based on the seller's commercial friends groups (e.g., product interest groups). As mentioned above, apart from the ad-hoc buyer groups to which the seller might have expressed an interest, the seller may also have expressed an interest in any number of commercial friend (or associate) groups of parties that share common consumer good and/or service interests. In such an example, advertising may be targeted to the seller based on the seller's membership in such groups.

In addition to or instead of targeted advertising, the advertising field 480 may present general non-targeted advertising to the seller.

The previous discussion presented various non-limiting exemplary aspects of a seller interface. Such aspects are merely illustrative and are non-limiting. Accordingly, the scope of various aspects of the present invention should not be limited by any particular characteristics of such exemplary aspects unless explicitly claimed.

The previous discussion generally focused on interface functionality provided by various aspects of the present invention and other functionality associated with such interface functionality. The following discussion will generally focus on additional functionality (e.g., buyer group formation, seller identification, interaction with sellers, coupling the buyer group and seller to complete the deal, performing and/or managing product delivery, collecting commissions from the transaction, etc.). The following discussion will generally present various aspects of the present invention, followed by illustrative exemplary operational scenarios.

Various aspects of the present invention comprise forming a buyer group. A system implementing various aspects of the present invention may, for example, operate to (e.g., including operate when enabled to) form a group of potential buyers (e.g., a buyer group) for a product (e.g., a consumer good and/or service). For example, such formation may comprise utilizing the interface functionality discussed above (e.g., any or all of the interface functionality related to buyer group definition and/or management). For example and without limitation, refer to the previous discussion of the buyer group definition interface.

Formation of a buyer group may be initiated and/or managed by any of variety of different types of individuals. As discussed above, a consumer or business (e.g., a buyer) can start a group by defining the group. Also for example, a broker/middleman can start a group. Additionally for example, a seller can start a group (e.g., identifying a product and price). Thus, any of the above-mentioned parties, for example, can initiate the formation of a buyer group. For example, any of such entities can initiate the formation of a buyer group utilizing a user interface adapted for such formation, non-limiting examples of which were presented previously. An entity forming and/or managing the buyer group may be referred to herein as the group initiator, group administrator, group moderator, group founder, etc.

A formed buyer group may then be populated. For example, a buyer group can be built to a desired size (or membership number). Also for example, a buyer group can be built for a particular amount of time. For example, the group founder (or moderator) can specify that the group will build for a month, at which time searching for a seller will begin. While building the group, a system implementing various aspects may, for example depend on the nature of the good and/or service proposed for purchase by the buyer group, notify potential members about the group. For example, in a scenario in which a buyer group is formed for a television purchase, the system may notify other users of the system that have expressed a desire to be notified when consumer electronics groups are formed. Such notifications may also be based on previous user purchases, buyer group memberships, memberships in related product interest groups, seller's lists of potential customers, etc. For example, when a user forms a buyer group, the system may notify all identified consumer friends (or associates) of the user.

Various aspects may also comprise performing filtering. Such filtering may, for example, be utilized to restrict group membership based on various criteria (e.g., criteria specified by the user during formation of the group). For example, during group formation, the entity forming the group may specify that the buyer group is only for people living in a particular geographical area. In such a scenario, buyer group membership may be denied to a potential group member who is located outside the geographical area specified for the buyer group that is being populated or who cannot provide a product delivery address within the geographical area.

Various aspects of the present invention comprise determining when the buyer group is complete or near complete. For example, a system implementing various aspects may wait until the group has reached a particular size before proceeding with a next phase of attempting to find a seller that is able and willing to meet the terms offered by the buyer group (if, e.g., such a seller has not already been specified or otherwise identified). For example, the administrator of the buyer group may have specified a minimum size of the group (e.g., to maximize group purchasing power, achieve a particular desired amount of purchasing power, etc.), after which such size is achieved the system is to locate a seller. Also for example, the administrator of the buyer group may have specified that the group grow for a particular period of time after which the system is to locate a seller. In another example, the system may determine that the buyer group is complete (or nearly so) when the growth rate of the group slows to a particular level. Additionally for example, the administrator of the group may indicate that the group is ready (e.g., by explicit user command, by responding to a query from the system, etc.). Further for example, the buyer group membership may vote (e.g., in a majority rule or quorum rule manner) to indicate that the group has been populated to a desired level and/or that the next phase of the process should begin. Also, for example, the system may determine or the administrator may indicate that the group is ready because the group has reached a size corresponding to the capacity of a desired seller (e.g., theater, restaurant, cruise chip, theme park, etc.)

Information describing one or more triggering events for such a group-completion determination may be published to all members and potential members of the buyer group. For example, in such a scenario, prior to joining a buyer group, a potential buyer group member may know that the group will have a particular minimum size to maximize purchasing power before attempting to locate a seller. Note that in various exemplary implementations a seller may be able to trigger a determination of group-completion by accepting the buyer group terms before the group has reached the originally desired size (e.g., offering the desired group discount to a group before such group has reached the originally set membership goals). Note also that the buyer group may continue to grow after the system determines to move onto a next phase (e.g., locating a seller). For example, to further incentivize potential sellers, such sellers may be notified of continued growth of the buyer group during negotiations with the seller.

As the buyer group is populated, the system may provide updates on the status of the group's growth. For example, the system may provide updates to individual group members on their personal consumer interface pages. Also for example, the system can provide updates to the buyer group on a buyer group interface (e.g., a web page or application) dedicated to (e.g., dedicated exclusively to) the buyer group. The updates can also be provided to other interested parties (e.g., a broker, potential sellers, other potentially interested buyers that may be interested in joining the buyer group, etc.). Updates on group status (e.g., including group membership status) may take any of a variety of forms, for example, web page messages, email messages, text messages, etc.

Various aspects of the present invention comprise identifying a seller that is willing to meet the demands of the buyer group and/or to best meet the demands of the buyer group. For example, a system implementing various aspects may (e.g., when a triggering point related to the formation of the buyer group is reached) find a seller that is willing to meet the terms specified for the buyer group. When the buyer group is ready (e.g., as indicated by size, time, group administrator command, membership vote, unsolicited seller acceptance, etc.) or near ready (e.g., reaching within a particular percentage of a goal), the system may begin attempting to find a seller willing and able to meet the buyer group terms.

As mentioned above, such seller interaction may begin at relatively early stages of buyer group development and continue throughout the group development. For example, potential sellers may be notified as a growing group reaches various growth milestones (e.g., membership number milestones, timeframe milestones, etc.). The system may, for example, utilizing a seller interface as discussed previously, specify group formation milestones at which the seller desires the system to notify the seller. Also for example, an interested seller may set a trigger point related to the buyer group size at which the seller will agree to the terms of the buyer group. In such an exemplary scenario, the buyer group may be notified of a seller's acceptance of their terms even before the buyer group has reached a growth milestone defined by the administrator of the group. For example, a seller may determine that the seller will agree to the buyer group's terms at a membership of 750 instead of waiting for the buyer group membership to meet a predefined milestone of 1000 members. The administrator of the group may then have the option of closing the deal before the planned membership of 1000 is met.

The system may operate to (e.g., including operate when enabled to) find a seller in any of a variety of manners, non-limiting examples of which will now be provided. For example, the system may contact known sellers (e.g., with which successful deals have been struck in the past, which have a good customer satisfaction rating, have specifically branded or desired products, etc.). Also for example, the system may conduct an auction. As discussed above, a buyer group may have been formed with terms that specify a maximum price, which may for example be hidden from sellers or communicated to sellers, but that also request an auction to determine a lowest-cost seller. In such a scenario, the system may perform an on-line auction involving potential sellers. Additionally for example, the system may contact sellers listed as preferred by the buyer group (e.g., sellers with a positive track record from the buyers' perspective). As discussed previously, such a list of preferred sellers may be input by a user when the group is originally designed, and may, for example, be modified after group formation. As mentioned above, such seller interaction may begin even before the buyer group has reached predefined growth objectives. Interaction with potential sellers may then continue while the group membership grows.

In an exemplary scenario in which the system fails to find a seller (e.g., failing to find a seller within a default period of time, within a period of time specified by the buyer group administrator, etc.), the system may provide a failure notification to the buyer group and/or administrator. In such a scenario, the administrator may, for example, propose new terms for the purchase (e.g., subject to individual re-approval by the group members, who would receive notification of such changed terms and an interface by which they may agree or opt out). Also for example, the administrator may form a new group with terms that are relatively more acceptable to a seller than the prior terms.

During the process of finding a seller, the system may provide updates on the process to the group (e.g., on a page dedicated to the buyer group, on respective personal consumer pages associated with group members, via email, via text or other instant messaging service, etc. During the process of finding a seller, the system may also interact with the buyer group (e.g., the group administrator) to approve an identified seller. In such a manner, undesirable sellers may be filtered out. Note that undesirable sellers may also be identified during buyer group formation (e.g., by a seller ID within the system that is assigned to a seller during seller registration with the system).

As discussed above, in various exemplary scenarios, a seller may form a buyer group and define such buyer group for interaction only with the seller. In such a scenario, the system need not find a seller since the seller has already been specified during formation of the buyer group. Also, non-seller buyer group administrators, for example during the group formation process, may also specify that the buyer group is only being formed for interaction with a particular seller or a particular defined plurality of sellers.

Various aspects of the present invention may comprise coupling the buyer group and the seller. For example, once a seller has been identified, the system may provide communication between the buyer group and the seller. Such communication may, for example, comprise communication regarding the terms of the deal, financial transaction information, etc. Such communication may, for example, comprise direct communication between the seller and the buyer group and/or communication via an implementer of the system that is serving as middle-man for the transaction.

The system may, for example, work with the parties to finalize purchase agreements. Such finalization may, for example, comprise automatic finalization without additional user interaction (e.g., in a scenario in which buyers have prepaid into an escrow). Also for example, such finalization may include the administrator and/or each of the buyers of the buyer group individually accepting the final terms agreed to by the seller.

Various aspects of the present invention may also comprise interfacing with a third party to handle the financial aspects of the deal. Note that the system may alternatively link the buyer group and the seller directly and exit the process (e.g., removing the middleman and placing the parties in direct communication with one another).

Various aspects of the present invention may also comprise performing and/or managing product delivery. For example, in various exemplary scenarios, the system (or associated enterprise) implementing the functionality discussed herein may maintain facilities and/or business relationships by which the delivery of product may be managed. For example, such operation (or a commission associated with such operation) may provide for another avenue of revenue for a deal broker. In such a scenario, the enterprise that brokered the deal for the buyer group may manage aspects of the shipping, providing shipping information to the buyer group, etc.

Various aspects of the present invention may additionally comprise collecting a commission, finder's fee, or other monies from the transaction. For example, at some point, the system (acting as broker for the deal) may (e.g., in a commission-based business model) receive a commission for brokering the deal. Such a commission may, for example, be specified before any buyer or seller activity (e.g., in a non-negotiable fixed manner). Such a commission may, for example, be specified as a function of the dollar amount of the deal (e.g., ranging from a minimum flat rate to a percentage of the deal that shrinks as the dollar value increases, as a fixed percentage of the deal, etc.).

For example, in an exemplary scenario in which the system is involved in the financial exchange, the system may capture the commission as monies pass through the system. If a third party is utilized in the financial exchange (e.g., an escrow company), the system may receive commission from the third party (e.g., passively or via active solicitation). In another exemplary scenario, the system may receive the commission from the seller as the seller receives the monies associated with the transaction. In yet another exemplary scenario in which the buyer group is paying the commission, the system may receive the commission from the buyer group (or individual members thereof) as part of the overall financial transaction.

There may also, for example, be a minimum commission payable by the buyer group even if a deal is not ultimately reached. Such a commission may, for example, compensate the system operators for the use of their resources by buyers that are too aggressive in their proposed terms to find a seller. As mentioned above, the commission or other payment form could be negotiable. For example, upon finding a seller, the system broker and seller may negotiate a fee before the system matches the seller to the buyer.

Various aspects of the present invention address financial concerns associated with the buyer group, seller, third party participant, and/or other party that provides any or all of the functionality discussed herein. Non-limiting examples of such financial functionality will now be presented.

For example, the sellers desire to be assured of receiving money for a large shipment of product to an ad hoc group. For example, unlike a shipment to a big-box store where the sellers have a defined target for legal recourse, the buyer group may be an ad hoc group formed for a single purchase and then disbanded, leaving the seller to seek legal resource against a large number of individuals. Also for example, the buyers desire to be assured that the seller will satisfy their commitments to deliver a quality product. For example, unlike a purchase from a big box store, the buyer may have a relatively difficult time being made whole if the seller fails to provide the product in a timely manner and in a suitable condition. Additionally for example, as discussed above, the broker (e.g., the enterprise administering the above-discussed functionality) must be assured to receive monies due thereto (e.g., commission, finder's fee, etc.). Further for example, depending on the method of shipment and delivery, other parties involved with such activities may also have concerns. For an implementation of a system implemented in accordance with various aspects of the present invention to be successful, the financial concerns of the various parties should be addressed (e.g., by the system, by a third party, etc.).

As discussed above, the system may maintain an escrow account (e.g., either directly or using a third party that is already set-up to perform such operation). In such a scenario a buyer may pay prior to shipment by the seller, and the seller may collect upon successful shipment and/or delivery and/or approval of the purchased product (e.g., a consumer good, a voucher for a consumer service, etc.). In such a scenario, after a deal is reached, the deal might hinge on a particular number of buyers placing money in the escrow account.

In an exemplary scenario, when the seller accepts the buyer group's terms, the system may provide the buyer group with a notice, upon which the buyers must put money into the escrow (or pay) within a particular time window, upon which the seller's acceptance will expire if the buyers, or a minimum number or percentage thereof, have not paid in. For example, if agreement is reached with a buyer group that purports to have 1000 members and only 400 of such buyers have paid by the end of a pay time window, the system may provide an interface by which the seller can back out of the deal or extend the window if enough progress is seen meeting the buyer group's commitments. Ultimate failure of the financial transaction may then, for example, result in the monies being returned to the buyers and the sales contract being voided. Such deal failure recovery may, for example, be performed by the system implementing various aspects of the present invention.

In another exemplary scenario, the buyers may be required to pay the seller directly prior to shipment, and the seller will manage the return of monies if too few members of the group pay. In such a scenario, the seller will be protected from providing a deep discount to a large group that ultimately fails to materialize. In such a scenario, the transfer of funds between the members of the buyer group and the seller may be managed by the system.

As discussed previously, various financial aspects of the deal may be specified and/or negotiated during the process of defining and/or maintaining the buyer group, during negotiations with the seller, etc. For example, the system may provide a buyer group interface and a seller interface by which the buyer group (e.g., an administrator thereof) and the seller may specify and/or negotiate such aspects. Such financial aspects may, for example, include specifying exactly when monies will be exchanged and/or under what conditions. The system implementing various aspects of the present invention may then manage the performance of such financial aspects (e.g., independently and/or in conjunction with a third party).

As a non-limiting example, the buyer group may, as part of its proposed terms for the deal, specify that each buyer is obligated to return and/or pay for the purchased product within two weeks of delivery to the buyer. A seller will then have the opportunity to avoid deals where such terms are unacceptable to the seller, or negotiate with the buyer group regarding unacceptable terms.

As mentioned above, a seller may also negotiate with the buyer group (e.g., the group administrator) regarding various terms of the proposed purchase. In an exemplary scenario, a seller that is willing to meet the purchase price and warrantee terms may negotiate with the buyer group (e.g., via the seller and/or buyer group interfaces discussed above) to address payment method details, shipping details, etc. A system implementing various aspects of the present invention may, for example, provide the interfaces utilized for such interaction, and the communicative coupling between such interfaces.

Various aspects of the present invention may also address privacy concerns associated with the buyer group, seller, third party participant, and/or other party that provides any or all of the functionality discussed herein. Non-limiting examples of such financial functionality will now be presented.

As mentioned previously, the members of a buyer group and the seller may have privacy concerns. For example, buyer group members and sellers might not want information of their purchases to be publicly available (e.g., for crime reasons, for status reasons, for future negotiations or pricing, etc.).

As mentioned previously, individual buyer identities may be protected and hidden from the general public and even from the other buyers in the group. For example, in an address-based shipping scenario, delivery address might only be provided by the system to those involved in the product shipment, financial transaction information might only be provided by the system to those involved in the financial transaction, etc.

Additionally for example, individual identity may be hidden from the general public and other members of the buyer group if desired. For example, buyers may use an alias for their involvement in a buyer group. Though various privacy measures, for example complete anonymity may detract from some of the socially beneficial aspects of the system (e.g., communicating with friends regarding purchases and potential purchases), the system may still provide such measures for users who prefer such privacy measures.

Alternatively, for example, a buyer can specify, for example via an interface provided by the system, that their personal page information be shared with others to enhance communication between buyers, to motivate others to join a buyer group, or for other beneficial reasons (social, consumer, or otherwise.). The system may then, for example, share such information as specified by the buyer.

Various aspects of the present invention may also provide a seller rating system. Non-limiting examples of such seller-rating functionality will now be presented.

As discussed previously, a user (e.g., an administrator for a buyer group) may specify that a deal may be struck only with a seller that meets a minimum customer satisfaction rating. Various aspects of the system may, for example, provide buyers with an interface by which the buyers can rate their experiences with sellers. For example, the system may maintain a database of seller profiles, where such profiles include information of consumer feedback regarding the sellers. A portion of such consumer feedback may, for example, comprise buyer feedback in the form of a rating scale (e.g., 1-10 scale, number-of-stars scale, thumb-up-or-down scale, etc.)

In an exemplary scenario, as part of the buyer group transaction, the system may solicit input from the group members (e.g., from all members, from the buyer group administrator, etc.) regarding the transaction and/or seller. For example, within a particular time period following a transaction, the system may message the members of the buyer group to solicit input from the buyer group members regarding the seller. Information of sellers may then be made available to the buyers in a buyer group for their consideration in determining whether to work with a particular seller.

Also for example (e.g., out of fairness to sellers), the system may comprise a seller interface mechanism by which the seller can request communication with the system implementer and/or an independent third party to resolve ratings that the seller believes are unfair. For example, a seller that has been unfairly prejudiced by a poor rating from an anonymous buyer may appeal such rating.

Additionally, as mentioned above, the buyer group formation process may comprise providing user interface functionality by which the buyer group administrator may filter out particular sellers that the group refuses to do business with.

As mentioned previously, for example in the discussion of seller-related interfaces, various aspects of the system may provide any of a variety of different types of functionality to sellers. Such functionality, which is exemplified elsewhere herein, may comprise interface functionality, database maintenance functionality, communication functionality, contract formation functionality, contract performance functionality, etc

Various aspects of the present invention will now be presented by way of a number of exemplary scenarios. Such exemplary scenarios are for illustrative purposes only and are non-limiting. Accordingly, the scope of various aspects of the present invention should not be limited by characteristics of any particular example unless explicitly claimed.

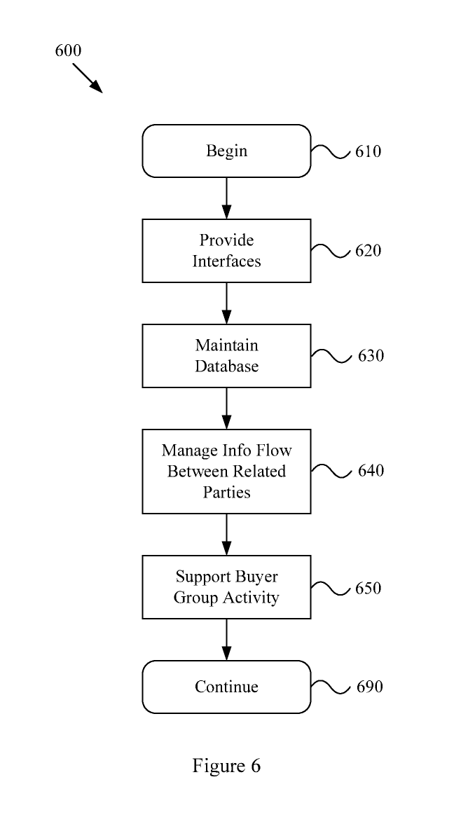

Turning to FIG. 6, such figure shows a flow diagram of a non-limiting exemplary method 600 for managing buyer group activity, in accordance with various aspects of the present invention. The method 600 may, for example at step 610, begin executing. The method 600 may begin executing in response to any of a variety of causes and/or conditions.

The method 600 may, for example at step 620, comprise providing various interfaces. Such interfaces may comprise any or all of the interfaces discussed above, including without limitation personal consumer interfaces for individuals (including aspects for buyer group interaction, product interest group interaction, social friend interaction, etc.), interfaces for forming and/or interfacing with buyer groups (e.g., ad hoc buyer groups), interfaces for forming and/or interfacing with product interest groups, etc.

The method 600 may, for example at step 630, comprise maintaining a database of relationships between individuals, ad hoc buyer groups, product interest groups, sellers, third party enterprises involved in transactions, financial information, etc. Many non-limiting examples of individual information, buyer group information, product interest group information, seller information, etc. were provided above. Step 630 may, for example, comprise managing membership in any of the various groups discussed above and managing relationships between any of the previously discussed parties, managing registration of buyers and/or buyer groups, etc. Many examples of such membership and/or relationships have been presented herein.

The method 600 may, for example at step 640, comprise managing the information flow between individuals, groups, sellers, and/or other enterprises in the system. For example, step 640 may comprise managing the flow of buyer group information to, from and/or between members of buyer groups (e.g., ad hoc buyer groups formed for a single purchase). Also for example, step 640 may comprise managing the flow of information to, from and/or between members of product interest groups (e.g., standing groups with a common interest in a particular product or product type). Additionally for example, step 640 may comprise managing the flow of information between a buyer group and various commercial enterprises involved in a transaction (e.g., a seller, shipping company, escrow company or other financial services, etc.). Further for example, step 640 may comprise managing the flow of information between social friends. Many non-limiting examples of such information flow and interaction between parties were provided above.

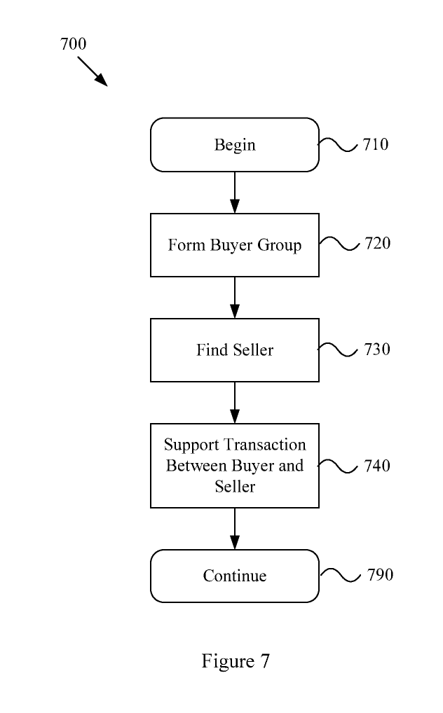

The method 600 may, for example at step 650, comprise supporting buyer group purchase activity. Many non-limiting examples of such functionality were presented above, including but not limited to: assisting in group formation and maintenance, assisting in brokering a deal between a buyer group and a seller (e.g., including assisting with negotiations), assisting with financial aspects, assisting with delivery, etc. Step 650 may also, for example, share any or all aspects with exemplary method 700 illustrated in FIG. 7 and discussed below.

The method 600 may, for example, at step 690, comprise performing continued processing, many non-limiting examples of which have been provided herein. In general, the illustrative method 600 shows a non-limiting method for managing buyer group activity. Such exemplary method 600 is non-limiting. Accordingly, the scope of various aspects of the present invention should not be limited by any characteristics thereof unless explicitly claimed.

Turning next to FIG. 7, such figure shows a flow diagram of a non-limiting exemplary method 700 for managing buyer group formation and purchase, in accordance with various aspects of the present invention. The method 700 may, for example at step 710, begin executing. The method 700 may begin executing in response to any of a variety of causes or conditions. For example, a user, having determined to form a buyer group for a desired purchase may visit a website of a provider of the functionality discussed here, log in as a registered user, and express an interest in forming a buyer group.

The method 700 may, for example at step 720, comprise forming a buyer group. For example and without limitation, step 720 may comprise interacting with a user (e.g., an administrator thereof) in any or all of the manners discussed herein (e.g., with regard to the buyer group definition interface). Step 720 may, for example and without limitation, share any or all characteristics with the exemplary method 700 illustrated in FIG. 7 and discussed below.

The method 700 may, for example at step 730, comprise finding a seller for the buyer group. Many non-limiting examples of such finding were provided previously. For example and without limitation, step 730 may comprise soliciting individual sellers to find a seller willing and able to meet the buyer group terms. Also for example, step 730 may comprise performing an auction (e.g., an on-line auction) to identify a seller that offers the best terms to the buyer group. Further for example, step 730 may comprise managing the communication of offers and counter-offers between buyer groups and sellers.

The method 700 may, for example at step 740, comprise supporting a commercial transaction (e.g., the purchase of consumer goods and/or services) between the buyer group and the seller. Many non-limiting examples of such support were provided previously. For example and without limitation, step 740 may comprise brokering the deal, managing financial transactions, providing and/or managing delivery of purchased product, managing the flow of information between various parties, etc.

The method 700 may, for example, at step 790, comprise performing continued processing, many non-limiting examples of which have been provided herein. For example and without limitation, step 790 may comprise collecting commission monies, continued communication with the transaction parties, providing for seller rating, etc.

In general, the exemplary method 700 comprises a non-limiting illustrative method for managing buyer group formation and purchase. Accordingly, the scope of various aspects of the present invention should not be limited by characteristics thereof unless explicitly claimed.

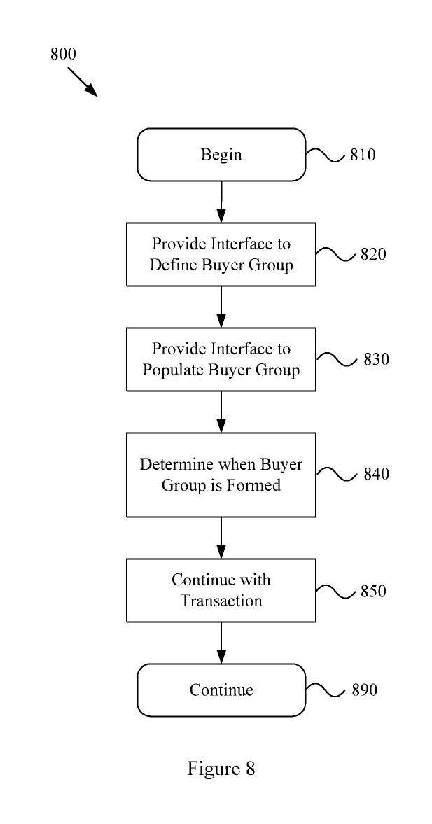

Turning next to FIG. 8, such figure shows a flow diagram of a non-limiting exemplary method 800 for forming a buyer group (e.g., an ad-hoc buyer group), in accordance with various aspects of the present invention. The method 800 may, for example at step 810, begin executing. The method 800 may begin executing in response to any of a variety of causes and/or conditions. For example, the method 800 may begin executing in response to a user expressing, via an interface (web-based or otherwise), a desire to form a buyer group for a particular purchase or set of purchases.

The method 800 may, for example at step 820, comprise providing an interface by which a buyer group may be defined. Many exemplary characteristics of such an interface were discussed above. Step 820 may, for example, comprise providing an interface by which an ad hoc buyer group may be defined for a single purchase of a consumer good and/or purchase in bulk by the buyer group.

The method 800 may, for example at step 830, comprise providing an interface by which interested individuals may populate a defined buyer group. Many examples of such functionality were presented above. For example and without limitation, step 830 may comprise advertising a newly formed buyer group to potentially interested buyers to draw attention to such buyer group, and then provide interface features by which individual buyers may view the proposed terms of the buyer group's proposed bulk purchase, and join such buyer group if interested in the proposed bulk purchase.

The method 800 may, for example at step 840, comprise determining when the buyer group is complete (or, for example, complete enough to move forward with the transaction). Many non-limiting examples of such determination were provided previously. For example and without limitation, step 840 may comprise determining that membership in the buyer group has reached a particular level, that a time limit associated with growth of the group has been reached, when a seller or the buyer group administrator indicates that the group is large enough, etc.

The method 800 may, for example at step 850, comprise continuing support of the transaction activities associated with the formed buyer group. Many non-limiting examples of such activities were presented previously (e.g., with regard to the interface discussions, with regard to steps 730 et al. of the method 700 shown in FIG. 7, etc.). For example and without limitation step 850 may comprise finding a seller, brokering the deal, managing the deal, managing information flow between the parties, etc.

In general, the exemplary method 800 comprises a non-limiting illustrative method for forming a buyer group. Accordingly, the scope of various aspects of the present invention should not be limited by characteristics thereof unless explicitly claimed.

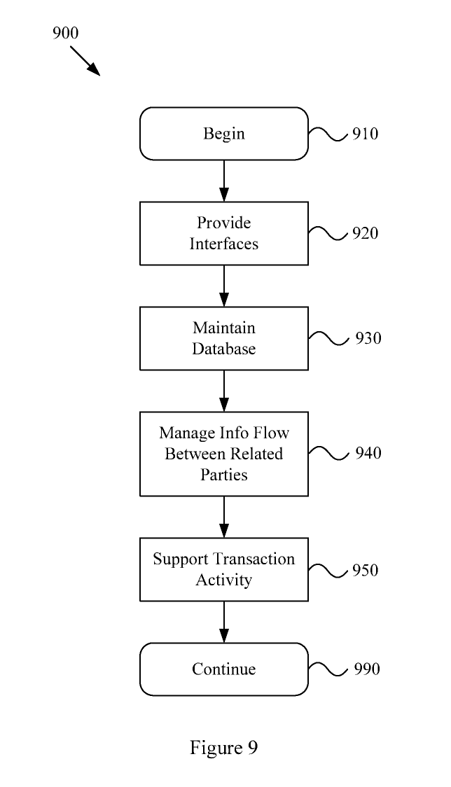

Turning next to FIG. 9, such figure shows a flow diagram of a non-limiting exemplary method 900 for managing seller activity, in accordance with various aspects of the present invention. The method 900 may, for example at step 910, begin executing. The method 900 may begin executing in response to any of a variety of causes and/or conditions.

The method 900 may, for example at step 920, comprise providing various interfaces. Such interfaces may comprise any or all of the interfaces discussed above, including without limitation seller interfaces (including aspects for buyer group interaction, product interest group interaction, third party interaction, etc.), interfaces for forming and/or interfacing with buyer groups (e.g., ad hoc buyer groups), interfaces for forming and/or interfacing with product interest groups, etc.

The method 900 may, for example at step 930, comprise maintaining a database of relationships between individuals, ad hoc buyer groups, product interest groups, sellers, third party enterprises involved in transactions, financial information, etc. Many non-limiting examples of individual information, buyer group information, product interest group information, seller information, etc. were provided above. Step 930 may, for example, comprise managing seller membership in any of the various groups discussed above and managing relationships between any of the previously discussed parties, managing registration of sellers, etc. Many examples of such membership and/or relationships have been presented herein.

The method 900 may, for example at step 940, comprise managing the information flow between individuals, groups, sellers, and/or other enterprises in the system. For example, step 940 may comprise managing the flow of information to, from and/or between members of product interest groups (e.g., standing groups with a common interest in a particular product or product type). Additionally for example, step 940 may comprise managing the flow of information between a seller and other parties involved in a transaction (e.g., other seller, shipping company, escrow company or other financial services, buyer groups, etc.).

The method 900 may, for example at step 950, comprise supporting transaction activity. Many non-limiting examples of such functionality were presented above, including but not limited to: assisting in group formation and maintenance, assisting in brokering a deal between a buyer group and a seller (e.g., including assisting with negotiations), assisting with financial aspects, assisting with delivery, etc.

The method 900 may, for example, at step 990, comprise performing continued processing, many non-limiting examples of which have been provided herein. In general, the illustrative method 900 shows an exemplary method 900 for managing seller activity. Such exemplary method 900 is non-limiting. Accordingly, the scope of various aspects of the present invention should not be limited by any characteristics thereof unless explicitly claimed.

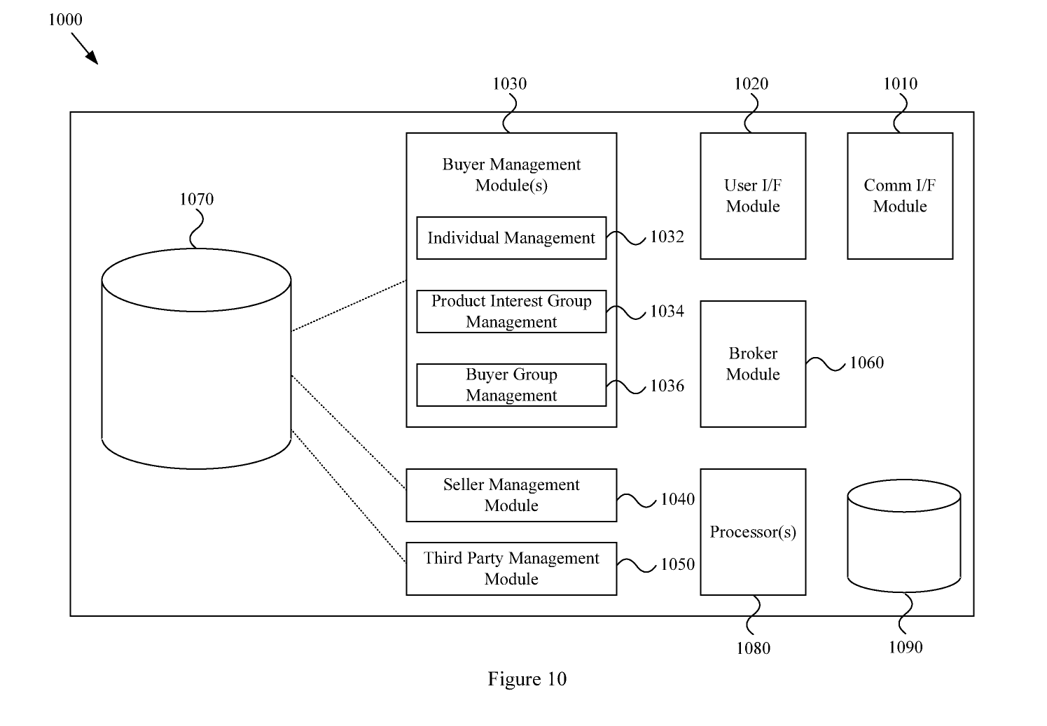

Turning next to FIG. 10, such figure shows a block diagram of a non-limiting exemplary system 1000 for managing buyer group activity, in accordance with various aspects of the present invention.

The exemplary system 1000 may, for example, be a distributed system with various components located at geographically distinct sites. Also for example, the system 1000 may be located at a single central location. Further for example, the system 1000 (or portions thereof) may be replicated at geographically distinct locations (e.g., in population centers, etc.).

The exemplary system 1000 may, for example, comprise a communication interface module 1010 that operates to (e.g., including operates when enabled to) communicate over any of a variety of communication networks (e.g., communicate with buyers and sellers). The communication interface module 1010 may, for example, operate to communicate over the Internet, via a telecommunication system, via a wireless communication system, via metropolitan and/or local area networks, etc. The communication interface module 1010 may, for example, operate to perform any or all types of communication that have been discussed herein.

The exemplary system 1000 may, for example, comprise a user interface module 1020 that operates to (e.g., including operates when enabled to) perform any or all of the user interface functionality discussed herein. As non-limiting examples, the user interface module 1020 may utilize the communication interface module 1010 to communicate user interface information (e.g., web page information) with various parties (e.g., via the Internet). Additionally, for example, the user interface module 1020 may also operate to provide any or all of the interface functionality discussed herein to a user local to the system 1000.

The exemplary system 1000 may, for example, comprise a buyer management module 1030. Such a buyer management module 1030 may, for example, operate to (e.g., including operate when enabled to) perform any of the buyer management and/or interaction functionality discussed herein. For example, such functionality may comprise managing and/or interfacing with individuals (e.g., individual buyers, group members, etc.), managing and/or interfacing with product interest groups, managing and/or interfacing with buyer groups, etc.). The buyer management module 1030 may, for example, utilize the user interface module 1020 and/or communication interface module 1010 to communicate with users, general product interest groups, ad hoc buyer groups.

The exemplary system 1000 may, for example, comprise a seller management module 1040. Such a seller management module 1040 may, for example, operate to (e.g., including operate when enabled to) perform any or all of the seller management and/or interaction functionality discussed herein. For example, such functionality may comprise communicating with sellers regarding buyer group terms, financial information, shipping information, etc. The buyer management module 1030 may, for example, utilize the user interface module 1020 and/or communication interface module 1010 to communicate with sellers, providing communication links between sellers and other parties to a transaction, etc.

The exemplary system 1000 may, for example, comprise a third party management module 1050. Such a third party management module 1050 may, for example, operate to (e.g., including operate when enabled to) perform any or all of the functionality discussed herein with regard to third parties (e.g., parties other than the buyers and sellers). As non-limiting examples, such a third party management module 1050 may operate to interact with escrow companies, shipping companies, credit card companies, etc., any of which may play a role in ultimate establishment and/or performance of a purchase contract (or purchase agreement) formed by the system between a buyer group and a seller. Note that the third party management module 1050 may utilize the user interface module 1020 and the communication interface module 1010 to communicate with sellers or potential sellers.

The exemplary system 1000 may, for example, comprise a broker module 1060 that operates to perform any or all of the broker functionality discussed herein. For example and without limitation, the broker module 1060 may operate to (e.g., including operate when enabled to) query sellers to find a seller that is able and willing to meet the buyer group's demands. Also for example, the broker module 760 may operate to perform an auction (e.g., an on-line auction) to find a most desirable seller from the perspective of various parties (e.g., from the perspective of the buyer's group, from the perspective of the commercial enterprise running the system 1000, etc.

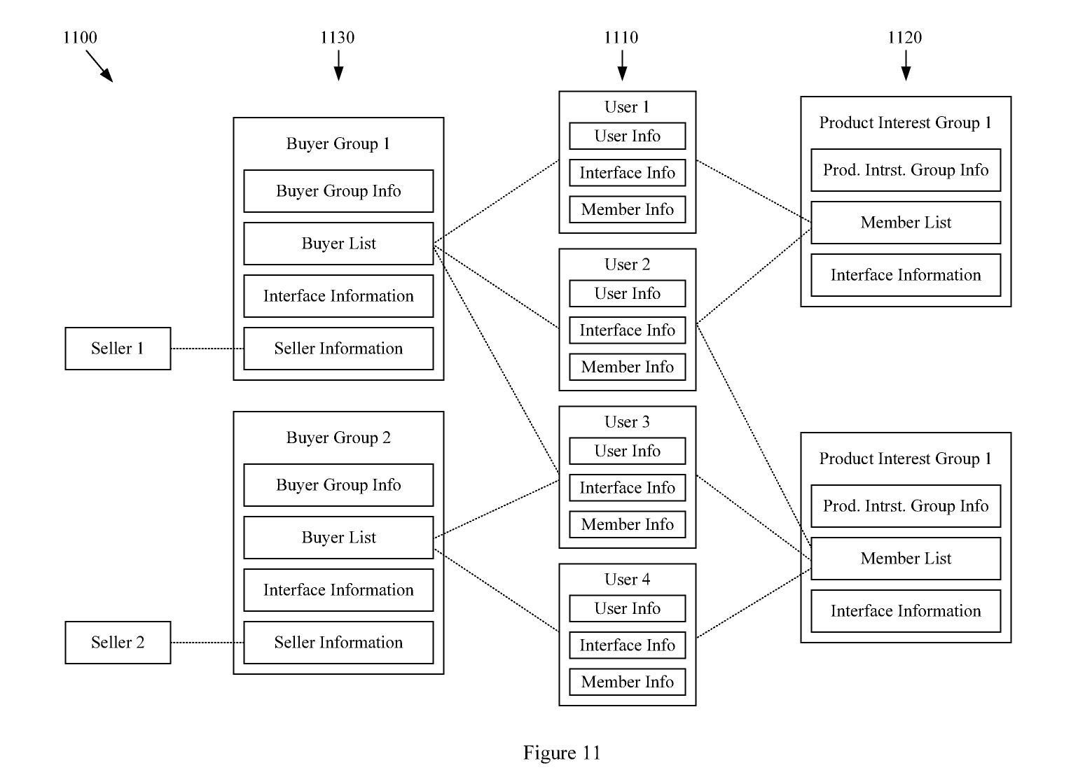

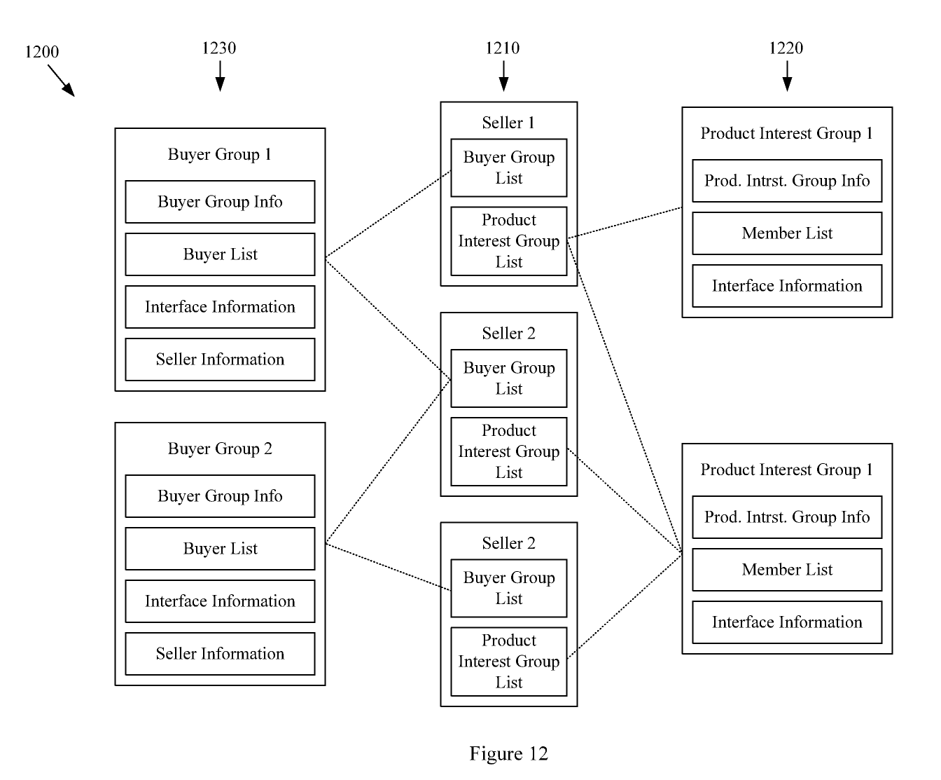

The exemplary system 1000 may, for example, comprise a database 1070 in which information related to users, product interest groups, buyer groups, sellers, third parties, etc. is stored in a conveniently accessible manner. For example and without limitation, the database 1070 may operate to (e.g., including operate when enabled to) store any or all of the different types of information discussed here, including for example, information describing the relationships between various entities. FIGS. 11 and 12 below will provide additional non-limiting examples of such information and/or relationships. Note that the database 1070 will likely be linked to one or more off-site back-up databases for the preservation of user, group and seller information.

The exemplary system 1000 may, for example, comprise one or more processors 1080 that operate to (e.g., including operate when enabled to) perform any or all of the functionality discussed herein. For example, any or all of the functional modules discussed herein may be executed by a processor executing software instructions (e.g., in accordance with the textual descriptions and/or flowcharts discussed herein). Such a processor and software instructions may be shared between modules also. Accordingly, the scope of various aspects of the present invention should not be limited by arbitrary boundaries between hardware and software unless explicitly claimed.

The exemplary system 1000 may, for example, comprise a memory 1090 that operates to (e.g., including operates when enabled to) store instructions and data for the processor(s) 1080. The memory 1090 may, for example, be a separate memory unit from the database 1070 or may be the same.

In general, FIG. 10 shows a non-limiting illustrative system 1000 for managing buyer group, seller, third party, and/or commercial transaction activity. Accordingly, the scope of various aspects of the present invention should not be limited by any particular characteristics thereof unless explicitly claimed.

Turning next to FIG. 11, such figure shows a diagram of a non-limiting exemplary data structure environment 1100 that may be utilized for managing buyer group activity, in accordance with various aspects of the present invention.

For example, the exemplary environment 1100 may comprise a set of user records (or files, etc.) 1110. Each of such user records may, for example and without limitation, comprise any or all of the user information discussed herein. For example, such user records 1110 may comprise information describing (or linking to) an interface that is provided to the user (e.g., information of a personal web page).

Also for example, the exemplary environment 1100 may comprise a set of general product interest group records 1120. The product interest group records 1120 may, for example, include information describing the product interest group (e.g., describing the general types of products in which the interest group is interested, any of all product interest group information discussed here, etc.). Such product interest group records 1120 may, for example, include membership information linking the product interest group records 1120 to each group's respective members in the set of user records 1110. Such product interest group records 1120 may also, for example, comprise information describing (or linking to) an interface that is provided to members of the particular product interest group (e.g., information of a product interest group web page).

Also for example, the exemplary environment 1100 may comprise a set of buyer group (e.g., ad hoc buyer group) records 1130. The buyer group records 1130 may, for example, include information describing or otherwise related to the buyer group (e.g., describing the consumer good and/or service in which the buyer group is trying to purchase, the terms that the buyer group is seeking, the membership information, any or all buyer group information discussed herein, etc.). Such buyer group records 1130 may, for example, include membership information linking the buyer group records 1130 to each group's respective members in the set of user records 1110. Such buyer group records 1130 may also, for example, comprise information describing (or linking to) an interface that is provided to members of the buyer group (e.g., information of a buyer group web page).

In general, FIG. 11 shows a non-limiting example of a data structure environment that may be utilized for managing buyer group activity, seller activity, third party activity, etc. Accordingly, the scope of various aspects of the present invention should not be limited by any particular characteristics of such example unless explicitly claimed.

Turning next to FIG. 12, such figure shows a diagram of a non-limiting exemplary data structure environment that may be utilized for managing seller activity, in accordance with various aspects of the present invention.

For example, the exemplary environment 1200 may comprise a set of seller records (or files, etc.) 1210. Each of such seller records 1210 may, for example and without limitation, comprise any or all of the seller information discussed herein. For example, such seller records 1210 may comprise information describing (or linking to) an interface that is provided to the seller (e.g., information of a web page). Such seller records 1210 may also, for example, comprise information linking to buyer group records of interest, seller group records of interest, etc.

Also for example, the exemplary environment 1200 may comprise a set of general product interest group records 1220. The product interest group records 1220 may, for example, include information describing the product interest group (e.g., describing the general types of products in which the interest group is interested, any of all product interest group information discussed here, etc.). Such product interest group records 1220 may, for example, include membership information linking the product interest group records 1220 to each group's respective members in the set of user records 1210. Such product interest group records 1220 may also, for example, comprise information describing (or linking to) an interface that is provided to members of the particular product interest group (e.g., information of a product interest group web page).

Also for example, the exemplary environment 1200 may comprise a set of buyer group (e.g., ad hoc buyer group) records 1230. The buyer group records 1230 may, for example, include information describing or otherwise related to the buyer group (e.g., describing the consumer good and/or service in which the buyer group is trying to purchase, the terms that the buyer group is seeking, the membership information, any or all buyer group information discussed herein, etc.). Such buyer group records 1230 may, for example, include membership information linking the buyer group records 1230 to each group's respective members in a set of user records. Such buyer group records 1230 may also, for example, comprise information describing (or linking to) an interface that is provided to members of the buyer group (e.g., information of a buyer group web page).

In general, FIG. 12 shows a non-limiting example of a data structure environment that may be utilized for managing seller activity, third party activity, buyer group activity, etc. Accordingly, the scope of various aspects of the present invention should not be limited by any particular characteristics of such example unless explicitly claimed.

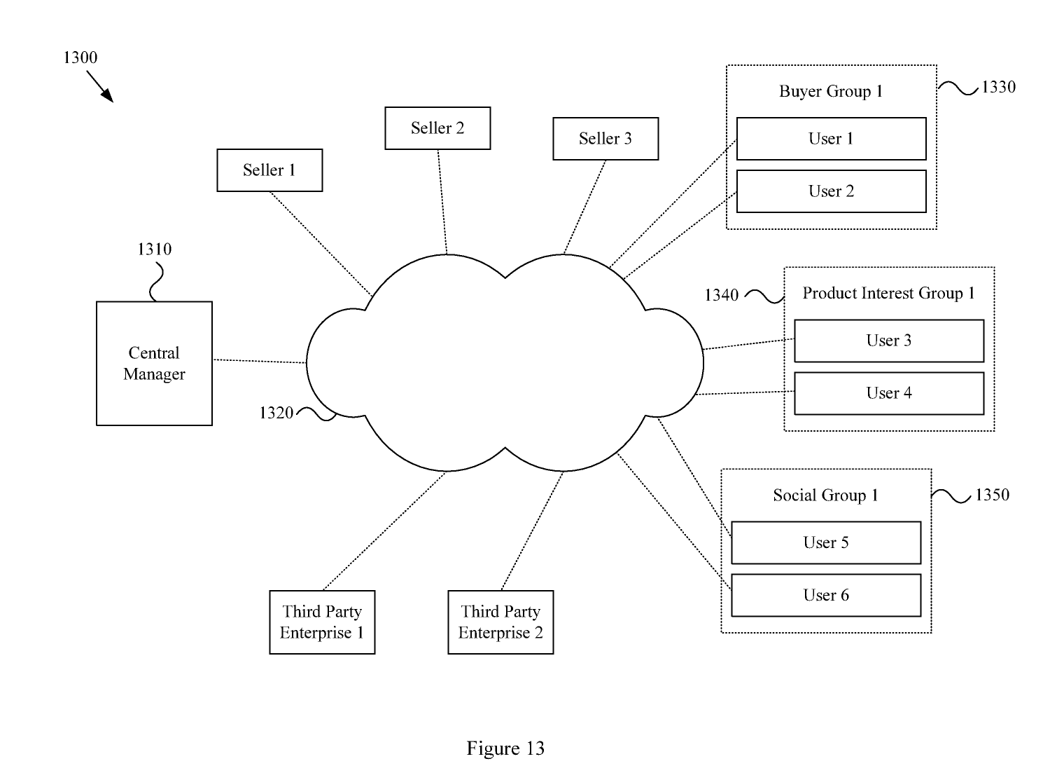

Turning next to FIG. 13, such figure shows a diagram of a non-limiting exemplary environment 1300 in which buyer group activity may be managed, in accordance with various aspects of the present invention.

The environment 1300 may, for example, comprise a central manager 1310. Such a central manager 1310 may, for example, share any or all characteristics with the exemplary system 1000 illustrated in FIG. 10 and discussed previously. For example, the central manager 1310 may manage buyer group activity, product interest group activity and/or individual user activity. As discussed above, a central manager 1310 may manage all systems, all systems within a geographical area, etc.

The environment 1300 may, for example, include a communication network 1320. Such communication network 1320 may comprise any of a variety of characteristics. For example, the communication network 1320 may comprise any one or more of the Internet, a wide area network, a metropolitan area network, a local area network, a telecommunication network, a general data communication network, a television network, and may utilize any one or more of a variety of communication media, including wired media, wireless media, tethered optical media, non-tethered optical media, etc.

The environment 1300 may, for example, include first and second users communicatively coupled to the central manager 1310 via the communication network 1320, where such first and second users are members of a buyer group 1330 (formed for the purchase of a product). The environment 1300 may, for example, include third and fourth users communicatively coupled to the central manager 1310 via the communication network 1320, where such third and fourth users are members of a general product interest group 1340 (formed for the purchase of communicating regarding a general product or product type). The environment 1300 may, for example, include fifth and sixth users communicatively coupled to the central manager 1310 via the communication network 1320, where such fifth and sixth users are not members of any ad hoc buyer group or product interest group, but are merely members of a social friend group 1350. Note that users may be members of any number of groups of each type illustrated.

The environment 1300 may, for example, include first, second, and third sellers communicatively coupled to the central manager 1310 via the communication network 1320. The central manager 1310 may, for example, operate to (e.g., including operate when enabled to) interact with the buyer group 1330 and the first, second, and/or third sellers via the communication network 1320 to broker and/or execute a deal between the buyer group 1330 and one of the first, second, and/or third sellers.

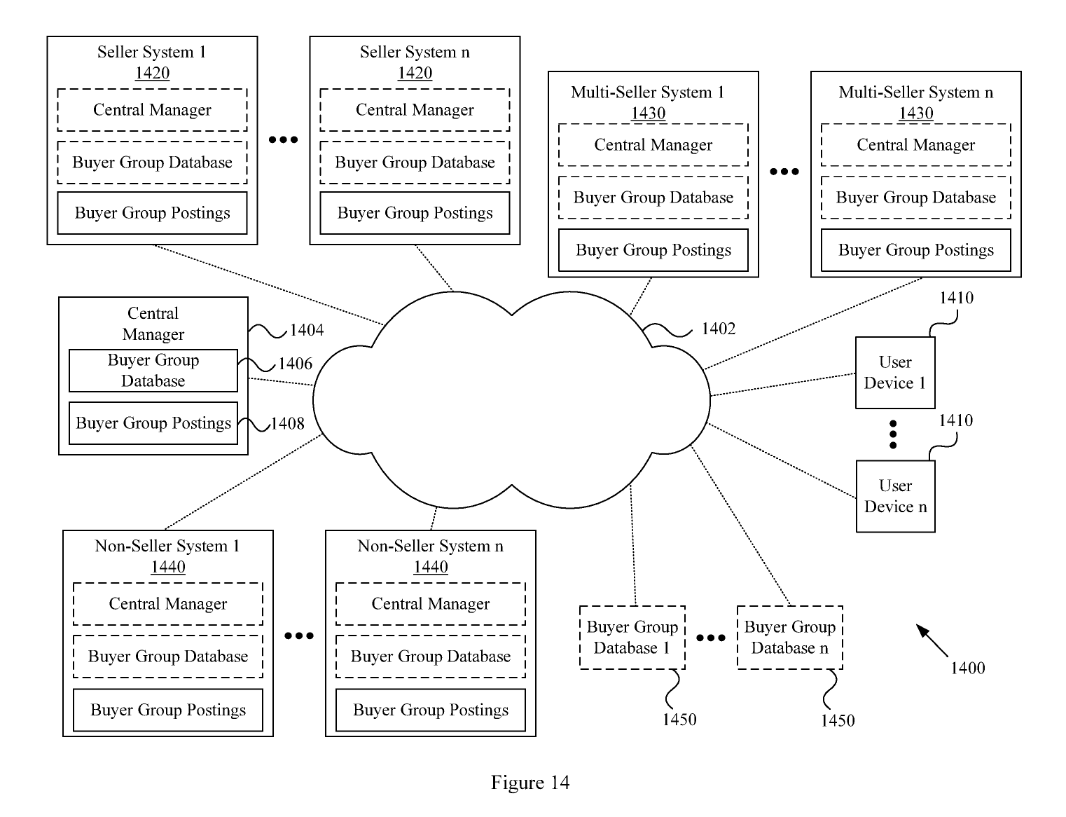

FIG. 14 shows a diagram of an overall on-line sales environment 1400 supporting various buyer group management implementations, in accordance with various aspects of the present invention. The on-line sales environment 1400 may comprise a communication network 1402 that communicatively couples various different entities as contemplated above. As mentioned above, such communication network 1402 may comprise any of a variety of characteristics. For example, the communication network 1402 may comprise any one or more of the Internet, a wide area network, a metropolitan area network, a local area network, a telecommunication network, a general data communication network, a television network, and may utilize any one or more of a variety of communication media, including wired media, wireless media, tethered optical media, non-tethered optical media, etc.

The on-line sales environment 1400 may also comprise a central manager 1404 (e.g., similar to or the same as central manager 1310) that is independently located and operated as its own web or application site, which may comprise a server or server environment supporting all of the functionality discussed above. The central manager 1404 comprises a buyer group database 1406 that stores buyer group information, as well as a user interface (such as, for example, one or more web pages or application screens, or portions thereof, as discussed above) that includes buyer group postings 1408, which are communicated to users via the communication network 1402. The buyer group postings 1408 can be viewed and selected by one or more of a plurality of users via a corresponding one or more of a plurality of user devices 1410 (e.g., computers, tablets, smartphones, etc.), enabling users to join the buyer group. The buyer group postings 1408 may also (or alternatively) be an advertisement and/or link that when selected, vectors users to another web or application site (e.g., a seller site, a multi-seller site, a non-selling site, etc.) for interaction with the given buyer group.

The on-line sales environment 1400 may also comprise a plurality of individual seller systems 1420 (e.g., manufacturers, single manufacturer retailers, service providers, etc.), multi-seller systems 1430 (e.g., Amazon™, eBay™, multiple manufacturer retailers, etc.), and non-selling systems 1440 (e.g., intermediary sites such as Google™, Yahoo™, Bing™, etc.) As shown in FIG. 14, any one of these entities may have or host all or a portion of the functionality discussed with respect to the central managers 1404 and 1310, including facilitating the creation and management of buyer groups, and buyer group postings, via their own server or server environment, and again support all of the functionality discussed above. Additionally (or alternatively), any one of these entities can simply host one or more buyer group postings 1408 from central manager 1404.

The on-line sales environment 1400 may also comprise a plurality of buyer group databases 1450, each of which may store buyer group information from one or more of the central manager 1404, the seller systems 1420, the multi-seller systems 1430, and the non-seller systems 1440. For example and without limitation, the buyer group databases 1450 enable cloud based storage of buyer group information.

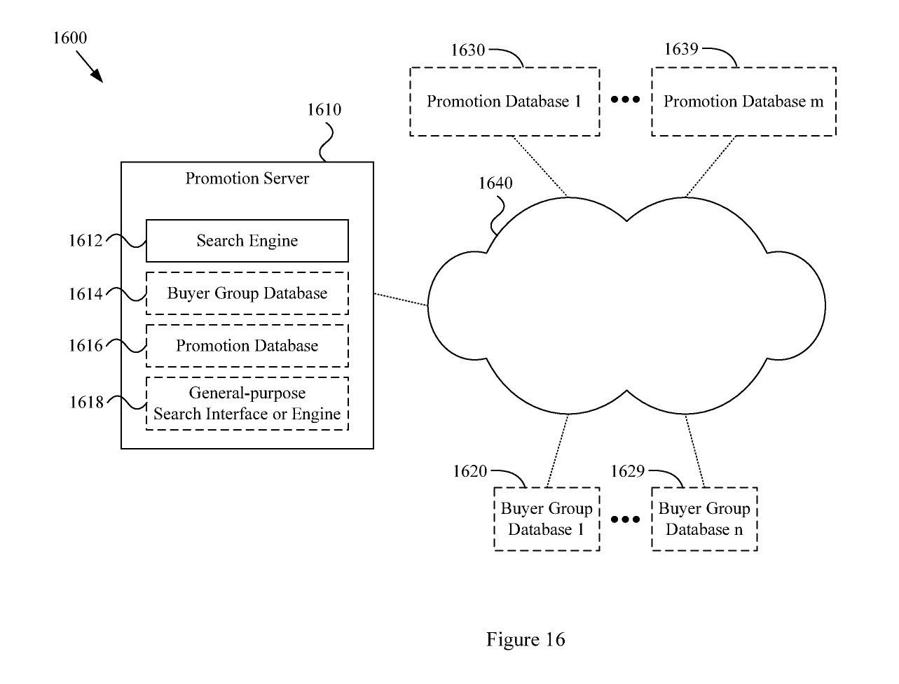

FIG. 16 shows a diagram of a promotion server searching environment 1600 in accordance with various aspects of the present invention. The exemplary environment 1600 shows a promotion server 1610, which facilitates the matching of promotions with buyer groups and vice versa, that is, the matching of buyer groups to promotions. The promotion server 1610 comprises a server or multiple servers, and may be part of an independent promotion entity that operates its own independent web or application site, or may be part of an independent buyer group entity having or supporting all of the functionality discussed above (e.g., with respect to central managers 1404 and 1310). Alternatively (or additionally), the promotion server 1610 may be located at a seller site, a buyer site, an intermediary site, etc. In other words, rather than (or in addition to) being part of an independent promotion entity or part of an independent buyer group entity, the promotion server 1610 may be part of (or the functionality thereof hosted by) any one of the entities identified with respect to FIG. 14, that is, any one of the individual seller systems 1420 (e.g., manufacturers, single manufacturer retailers, service providers, etc.), multi-seller systems 1430 (e.g., Amazon™, eBay™, multiple manufacturer retailers, etc.), and/or non-selling systems 1440 (e.g., intermediary sites such as Google™, Yahoo™, Bing™, etc.)

The promotion server 1610 may comprise or support a search engine 1612 (e.g., a local search engine) that conducts a search of a local buyer group database 1614 (e.g., without communicating over a wide area network, such as the Internet) for buyer group information and/or a search of a promotion database 1616 for promotion (e.g., prepaid credit cards, gift cards, store credits, coupons, vouchers, rebates, discounts, a percentage off, buy one get one free, buy one get one half off, buy ten get the eleventh free, advertisements, etc.) information. The promotion server 1610 may also comprise or support a general purpose search interface or engine 1618 (e.g., a 3^{rd}-party general-purpose Internet search interface or engine, like Google™, Yahoo™, Bing™, etc.) that searches a network of databases for buyer group and/or promotion information. For example, the exemplary environment 1600 shows n (an integer number) exemplary buyer group databases at items 1620-1629 and m (an integer number) exemplary promotion databases at items 1630-1639. The promotion server 1610 (e.g., the general-purpose search interface or engine 1618) is communicatively coupled to such databases 1620-1629 and 1630-1639 via one or more communication networks 1640 (e.g., the Internet, a local area network, a wide area network, a metropolitan area network, etc.). The general-purpose search interface or engine 1618 may, for example, operate to (e.g., including operate when enabled to) search any or all of the buyer group databases 1620-1629 and the promotion databases 1630-1639. As discussed above, operation of the search engine 1612 and the general-purpose search interface or engine 1618 may be coordinated (e.g., for concurrent searching using the same or similar search criteria, for serialized searching, etc.).

In operation, the promotion server 1610 may obtain or receive information regarding one or more promotions relevant to a particular product, product category or type, seller, manufacturer, etc. This may be achieved by various means, including, for example, by the promotion server 1610 searching for or hosting promotions, or otherwise receiving communications regarding promotions. Once the promotion server 1610 has identified a particular promotion relevant to a particular product, product category or type, entity, etc., the promotion server 1610 can then perform a search, using the search engine 1612 and the buyer group database 1614, to identify any buyer groups (either existing or being formed) that may be interested in the promotion or for which the promotion has applicability. Additionally (or alternatively), the promotion server 1610 can perform a search, using the general purpose search engine or interface 1618 and the buyer group databases 1620-1629, to identify any buyer groups (either existing or being formed) that may be interested in the promotion or for which the promotion has applicability. For example, the promotion may be an advertisement related to a particular product, product category or type, seller, manufacturer, etc. The promotion server 1610 may identify all buyer groups that have expressed an interest in the particular product, product category or type, seller, manufacturer, etc., and communicate the advertisement to the buyer group (e.g., via a central manager such as central managers 1404 and 1310 or by other means (e.g., email, text message, etc.) Also for example, the promotion may be a coupon or rebate relevant to the particular product, product category or type, seller, manufacturer, etc., or related to a product, product category or type, seller, manufacturer, etc. that is competitive with or complementary to the particular product, product category, seller, manufacturer, etc. Again, the promotion server 1610 may identify all buyer groups that have expressed an interest in the particular product, product category, seller, manufacturer, etc., and communicate the coupon or rebate to the identified buyer group(s) (e.g., via a central manager such as central managers 1404 and 1310 or by other means (e.g., email, text message, etc.).

In a further operation, the promotion server 1610 may obtain or receive information regarding one or more buyer groups relevant to a particular product, product category or type, seller, manufacturer, etc. This may be achieved by various means, including, for example, by the promotion server 1610 searching for or hosting buyer groups, or otherwise receiving communications regarding buyer groups. Once the promotion server 1610 has identified a particular buyer group (either existing or being formed) relevant to a particular product, product category or type, entity, etc., the promotion server 1610 can then perform a search, using the search engine 1612 and the promotion database 1616, to identify any promotions in which the particular buyer group may be interested or which may have applicability to the identified buyer group. Additionally (or alternatively), the promotion server 1610 can perform a search, using the general purpose search engine or interface 1618 and the promotion databases 1630-1639, to identify any promotions in which the particular buyer group may be interested or which may have applicability to the identified buyer group. Note that such local and distributed searching may be performed serially or simultaneously. For example, the promotion server 1610 may identify all promotions (e.g., advertisement(s)) that are relevant to the particular buyer group (e.g., based on expressed interest in the particular product, product category, seller, manufacturer, etc.), and communicate the advertisement(s) to the buyer group (e.g., via a central manager such as central managers 1404 and 1310 or by other means (e.g., email, text message, etc.) Also for example, once a buyer group has been identified, the promotion server 1610 may identify all coupon(s) or rebate(s) relevant to the buyer group (e.g., based on expressed interest in a particular product, product category, seller, manufacturer, etc., or based on an identification of a product, product category or type, seller, manufacturer, etc. that is related to, competitive with or complementary to the particular product, product category or type, seller, manufacturer, etc.) Again, the promotion server 1610 may communicate the coupon(s) or rebate(s) to the buyer group (e.g., via a central manager such as central managers 1404 and 1310 or by other means (e.g., email, text message, etc.).

Similarly as discussed above, operation of the search engine 1612 and the general-purpose search interface or engine 1618 may be coordinated (e.g., for concurrent searching using the same or similar search criteria, for serialized searching, etc.). Specifically, for example, search criteria may used by general-purpose search engine or interface 1618 (e.g., Google™, Yahoo™, Bing™, etc.) and/or by the search engine 1612 to search for specific promotions, and the system can automatically identify (e.g., by searching the buyer group database 1614 and/or buyer group databases 1620-1629) and present related buyer groups that have either already been formed or are being formed. As another example, search criteria may used by general-purpose search engine or interface 1618 (e.g., Google™, Yahoo™, Bing™, etc.) and/or by the search engine 1612 to search for specific buyer groups, and the system can automatically identify (e.g., by searching the promotion database 1616 and/or promotion databases 1630-1639) and present related promotions.

In either case, such identification may be based on the search criteria being used, or on the results of the search. In other words, the search criteria can be concurrently used to search for promotions, and to also search for buyer groups presumably related to the promotions, and likewise, the search criteria can be concurrently used to search for buyer groups, and to also search for promotions presumably related to the buyer groups. In one embodiment, the search criteria used for the general-purpose search interface or engine 1618 is automatically used to “populate” an interface for the search engine 1612, or the search criteria used for the search engine 1612 is automatically used to “populate” the general-purpose search interface or engine 1618, and in either case launch a search for applicable or related buyer groups and/or promotions (i.e., to match promotions with buyer groups and/or match buyer groups to promotions). Alternatively, the search criteria can be used to search for desired buyer groups and/or promotions. Once those buyer groups and/or promotions are specified (e.g., by selecting a visual object, such as a pictorial or graphical image, or text associated therewith, by selecting (e.g., selecting a hyperlink) and viewing information about those buyer groups and/or promotions, navigating to a web page associated with those buyer groups and/or promotions, etc.), then information regarding the selection (e.g., information regarding specified buyer groups and/or promotions (e.g., type, associated product, etc.), a category or categories related to specified buyer groups and/or promotions or in which the specified buyer groups and/or promotions are found, related complementary products, related competitive products, etc.) is used to search database(s) for promotions and/or buyer groups, as the case may be, to match one to the other.

Additionally, the searching aspects discussed above generally (and specifically those discussed in connection with FIGS. 14, 15 and 16) may be performed automatically without any user, seller or other operator input whatsoever. For example, for a buyer group entity such as described in connection with FIG. 15 or a promotion entity discussed in connection with FIG. 16 (or their variations, as discussed), where revenue may be generated by matching buyer groups to products and/or products to buyer groups, and/or by matching promotions to buyer groups and/or buyer groups to promotions, the search and match capabilities are automated to maximize revenue. In other words, those entities periodically and continually perform searches in attempts to identify desirable matches, and then undertake communications to take advantage of the identified matches. As a non-limiting, targeted advertising example, a promotion entity may periodically and automatically perform a search for buyer groups that are formed or being formed to match advertisements that are found in or are added to one or more promotion (e.g., advertisement) database(s), or alternatively (or additionally) a buyer group entity may periodically and automatically perform a search of one or more promotion (e.g., advertisement) databases for advertisements to match its hosted buyer groups that are formed or being formed. In either case, the matching advertisements are communicated to the buyer groups (e.g., as discussed above).

In summary, various aspects of the present invention provide a system and method for providing a demand driven promotion system supporting social networking and searching. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for organizing a groups of users for product purchases, the method comprising:
providing a buyer group definition interface by which a plurality of users input product identification information identifying products for purchase;
defining a plurality of buyer groups based, at least in part, on the input of product identification information from the plurality of users; and
associating each of the plurality of buyer groups with a respective one of the identified products for purchase.

2. The method of claim 1, comprising storing an association between each of the plurality of buyer groups with a respective one of the identified products for purchase.

3. The method of claim 1, comprising receiving input from a further user selecting a product, and identifying a buyer group associated with the product.

4. The method of claim 1, comprising receiving a search term from a further user, identifying a product corresponding to the search term, and identifying a buyer group associated with the product.

5. The method of claim 1, comprising for each of the plurality of buyer groups, enabling user members of the buyer group to communicate electronically.

6. The method of claim 1, comprising for each of the plurality of buyer groups, enabling one or more user members of the buyer group to communicate electronically with one or more sellers.

7. The method of claim 1, comprising identifying, for one or more of the identified products for purchase, one or more additional products related to the one or more products for purchase, and communicating information regarding the identified one or more additional products to one or more buyer groups respectively associated with the one or more of the identified products for purchase.

8. The method of claim 7, wherein the one or more additional products are complementary to the one or more of the identified products for purchase.

9. The method of claim 1, comprising identifying, for one or more of the identified products for purchase, one or more promotions related to the one or more products for purchase, and communicating the identified one or more promotions to one or more buyer groups respectively associated with the one or more of the identified products for purchase.

10. The method of claim 9, wherein the one or more promotions comprises one or more advertisements.

11. The method of claim 1, comprising populating each of the plurality of buyer groups based on input from further users.

12. A method for organizing a groups of users for product purchases, the method comprising:
providing a buyer group definition interface to a first user;
receiving via the buyer group definition interface from the first user, input of first product identification information identifying a first product;
defining a first buyer group based, at least in part, on the input of first product identification information from the first user;
associating the first buyer group with the first product information;
providing a buyer group definition interface to a second user;
receiving via the buyer group definition interface from the second user, input of second product identification information identifying a second product;
defining a second buyer group based, at least in part, on the input of second product identification information from the second user;
associating the second buyer group with the second product information;
receiving input from a first plurality of additional users, the input relating to the first product;
populating the first buyer group with the first plurality of additional users;
receiving input from a second plurality of additional users, the input relating to the second product; and
populating the second buyer group with the second plurality of additional users.

13. The method of claim 12, comprising:
storing a first association between the first buyer group and the first product information; and
storing a second association between the second buyer group and the second product information.

14. The method of claim 13, comprising:
identifying, for each of the first plurality of additional users, the first buyer group based on the first association; and
identifying, for each of the second plurality of additional users, the second buyer group based on the second association.

15. The method of claim 12, comprising:
receiving a search term from a further user;
based on the received search term, identifying one of the first product and the second product;
based on the identified one of the first product and the second product, identifying an associated one of the first buyer group and the second buyer group; and
communicating information regarding the identified associated one of the first buyer group and the second buyer group to the further user.

16. The method of claim 12, comprising:
for the first buyer group, enabling the first user to communicate electronically with the first plurality of additional users; and
for the second buyer group, enabling the second user to communicate electronically with the second plurality of additional users.

17. The method of claim 12, comprising:
for the first buyer group, enabling the first user to communicate electronically with a first seller; and
for the second buyer group, enabling the second user to communicate electronically with a second seller.

18. The method of claim 12, comprising:
identifying one or more first additional products related to the first product;
communicating information regarding the identified one or more first additional products to the first buyer group;
identifying one or more second additional products related to the second product;
communicating information regarding the identified one or more second additional products to the second buyer group.

19. The method of claim 18, wherein the one or more first additional products are complementary to the first product, and wherein the one or more second additional products are complementary to the second product.

20. The method of claim 12, comprising:
identifying one or more first promotions related to the first product;
communicating information regarding the identified one or more first promotions to the first buyer group;
identifying one or more second promotions related to the second product;
communicating information regarding the identified one or more second promotions to the second buyer group.

21. The method of claim 20, wherein the one or more first promotions and the one or more second promotions each comprise an advertisement.
